(19) United States
(12) Patent Application Publication
(10) Pub. No.: US 2026/0083635 A1
(43) Pub. Date: Mar. 26, 2026

(54) STACKING OF NESTS FOR PHARMACEUTICAL CONTAINERS

(71) Applicant: SCHOTT Pharma Schweiz AG, St. Gallen (CH)

(72) Inventors: Marcel Berlinger, St. Gallen (CH); Jörg Christoph Bieg, St. Gallen (CH)

(21) Appl. No.: 19/334,411

(22) Filed: Sep. 19, 2025

(30) Foreign Application Priority Data
Sep. 26, 2024 (EP) 24202809.0

(51) Int. Cl. A61J 1/05; A61J 1/16; B65D 21/02

(52) U.S. Cl. CPC A61J 1/05; A61J 1/16; B65D 21/0204

(57) ABSTRACT

A first structure including a first plurality of receptacles, for accommodating containers for pharmaceutical, medical, and/or cosmetic compositions, wherein the first plurality of receptacles include protrusions extending into interiors of the receptacles; wherein the first plurality of receptacles are adapted and arranged such that when the first structure is arranged in contact with a further structure, including a further plurality of receptacles, wherein the further plurality of receptacles include protrusions extending into interiors of the receptacles, at least one or all of the following applies: I. 30% or less of the first plurality of receptacles are in contact with the protrusions of the further plurality of receptacles, and/or, II. 30% or less of the further plurality of receptacles are in contact with the protrusions of the first plurality of receptacles.

This claims priority to European Patent Application 24202809.0, filed on Sep. 26, 2025, which is hereby incorporated by reference herein.

### FIELD OF THE INVENTION

The invention pertains to a structure for accommodating a plurality of containers, wherein said containers are preferably for accommodating pharmaceutical, medical and/or cosmetic compositions. The invention further pertains to an arrangement comprising at least two structures, as well as a method of processing at least two structures.

### BACKGROUND

Containers, such as containers for pharmaceutical, medical and/or cosmetic compositions, are generally accommodated (e.g., held) and transported using structures known as nests. Examples of such nests are the nests commercially available from SCHOTT Pharma AG & Co. KGaA. To accommodate the containers, a nest has a plurality of receptacles. The receptacles of a nest generally have protrusions (e.g., ribs) extending into the interiors of said receptacles. These protrusions are used for positioning containers accommodated in the receptacles. When transporting a plurality of structures, said structures are stacked onto each other such that the receptacles of an upper nest are almost completely inserted into the receptacles of the nest immediately below the upper nest. Consequently, the ribs of the receptacles of the lower structure and the receptacles of the upper structure have to be precisely dimensioned in order to accommodate the stacking of the structures. Furthermore, the ribs of the lower structure are very often in contact with receptacles of the upper structure, which leads to the ribs exerting a force on the receptacles over a limited area. This, amongst other problems, causes the ribs of the lower structure to damage the receptacles of the upper structure.

### SUMMARY OF THE INVENTION

An object of the present invention is to at least partially overcome at least one of the disadvantages encountered in the state of the art.

It is a further object of the invention to provide a structure (e.g., a first structure) for the accommodation of containers, preferably containers for accommodating pharmaceutical, medical and/or cosmetic compositions.

It is a further object of the invention to provide a structure (e.g., a first structure) for the accommodation of containers, wherein the structure allows for a reduction in the formation of particles on the structure when said structure is in contact with a further structure, e.g., the structure and the further structure are stacked onto each other.

It is a further object of the invention to provide a structure (e.g., a first structure) for the accommodation of containers, wherein said structure requires less force when stacking the structure and a further structure onto each other.

It is a further object of the invention to provide a structure (e.g., a first structure) for the accommodation of containers, wherein said structure allows for a reduced damage when the structure and a further structure are stacked onto each other.

It is a further object of the invention to provide a structure (e.g., a first structure) for the accommodation of containers, wherein said structure requires less force for the separation of the structure from a further structure when said structure and the said further structure are stacked onto each other.

It is a further object of the invention to provide a structure (e.g., a first structure) for the accommodation of containers, wherein said structure allows for a reduced damage when the structure is separated from a further structure when said structure and the said further structure are stacked onto each other.

It is a further object of the invention to provide a structure (e.g., a first structure) for the accommodation of containers, wherein said structure allows for an improved distribution of force when the structure and a further structure are stacked onto each other.

It is a further object of the invention to provide a structure (e.g., a first structure) for the accommodation of containers, wherein said structure allows for more consistent contact surfaces when the structure and a further structure are stacked onto each other.

It is a further object of the invention to provide a structure (e.g., a first structure) for the accommodation of containers, wherein said structure has a higher manufacturing tolerance.

It is a further object of the invention to provide a structure (e.g., a first structure) for the accommodation of containers, wherein said structure allows for an easier production of the nest with desired specifications.

It is a further object of the invention to provide a structure (e.g., a first structure) for the accommodation of containers, wherein said structure allows for improved protrusions, wherein said protrusions are for the positioning of containers in the structure.

It is a further object of the invention to provide a structure (e.g., a first structure) for the accommodation of containers, wherein said structure allows for a larger number of similar structures to be stacked onto each other.

It is a further object of the invention to provide a structure (e.g., a first structure) for the accommodation of containers, wherein said structure allows for a reduced movement relative to a further structure when said structure and said further structure are stacked onto each other.

It is a further object of the invention to provide a structure (e.g., a first structure) for the accommodation of containers, wherein said structure allows for an improved heat transfer between the structure and containers accommodated in said structure.

A contribution to at least partially fulfilling at least one of the above-mentioned objects is made by any of the embodiments of the invention.

A 1^{st} embodiment of the invention is a first structure comprising
a. a first plurality of receptacles, wherein each receptacle of the first plurality of receptacles
   i. is adapted and arranged for accommodating a container, preferably a container for accommodating a pharmaceutical, medical and/or cosmetic composition;
   ii. has a first end and a further end, opposite the first end,
   iii. comprises a sidewall that at least partially encloses, preferably encloses, an interior of the receptacle;
   iv. comprises at least one protrusion extending into the interior of the receptacle, wherein the at least one protrusion is preferably adapted and arranged for a positioning of a container in the receptacle;
wherein
   the first structure is adapted and arranged such that when the first structure is arranged in contact with a further structure that comprises a further plurality of receptacles, wherein each receptacle of the further plurality of receptacles
      i. is adapted and arranged for accommodating a container, preferably a container for accommodating a pharmaceutical, medical and/or cosmetic composition,
      ii. has a first end and a further end, opposite the first end,
      iii. comprises a sidewall that at least partially encloses, preferably encloses, an interior of the receptacle,
      iv. comprises at least one protrusion extending into the interior of the receptacle, wherein the at least one protrusion is preferably adapted and arranged for a positioning of a container in the receptacle;
   at least one or all of the following applies:
      I. 30% or less, preferably 20% or less, more preferably 10% or less, and further preferably 5% or less of the receptacles, forming part of the first plurality of receptacles, are in contact with the protrusions of the further plurality of receptacles, and/or,
      II. 30% or less, preferably 20% or less, more preferably 10% or less, and further preferably 5% or less of the receptacles, forming part of the further plurality of receptacles, are in contact with the protrusions of the first plurality of receptacles.

In an aspect of the 1^{st} embodiment, all possible combinations of the features I. and II. are preferred aspects of the embodiment. These combinations are e.g., I; II; I+II. In an aspect of the 1^{st} embodiment, it is preferred that the at least one protrusion is adapted and arranged for at least one or all of the following: positioning the container during insertion of the container into the respective receptacle, positioning the container during removal of the container from the respective receptacle, positioning the container during an accommodation of the container in the respective receptacle. In a preferred aspect of the 1^{st} embodiment, the first structure is adapted and arranged to be detachably engaged with the further structure. In a preferred aspect of the 1^{st} embodiment, the first plurality of receptacles are adapted and arranged to form a form-fit with the further plurality of receptacles. In the 1^{st} embodiment, a preferred form of contact between the first structure and the further structure includes the following: the first structure is stacked onto and/or in the further structure, the further structure is stacked onto and/or in the first structure.

In a preferred embodiment of the first structure, at least one or all of the following applies when the first structure is arranged in contact with a further structure:
a. 20% or less, preferably 15% or less, more preferably 10% or less, and further preferably 5% or less of a maximum length of the receptacles, of the first plurality of receptacles, are in contact with the protrusions of the further plurality of receptacles;
b. 20% or less, preferably 15% or less, more preferably 10% or less, and further preferably 5% or less of a maximum length of the receptacles, of the further plurality of receptacles, are in contact with the protrusions of the first plurality of receptacles.

This preferred embodiment is a 2^{nd} embodiment of the invention, that preferably depends on the 1^{st} embodiment of the invention.

In an aspect of the 2^{nd} embodiment, all possible combinations of the features a. and b. are preferred aspects of the embodiment. These combinations are e.g., a; b; a+b. The 2^{nd} embodiment, feature a., should be understood to apply to receptacles, of the first plurality of receptacles, that are in contact with the protrusions of the further plurality of receptacles. The 2^{nd} embodiment, feature b., should be understood to apply to receptacles, of the further plurality of receptacles, that are in contact with the protrusions of the first plurality of receptacles.

In a preferred embodiment of the first structure, at least one or all of the following applies when the first structure is arranged in contact with a further structure:
a. a length of the sidewall of a respective receptacle, of the first plurality of receptacles, that is in contact with at least one protrusion of the further plurality of receptacles is 10 mm or less, preferably 7 mm or less, more preferably 5 mm or less, and further preferably 3 mm or less;
b. a length of the sidewall of a respective receptacle, of the further plurality of receptacles, that is in contact with at least one protrusion of the first plurality of receptacles is 10 mm or less, preferably 7 mm or less, more preferably 5 mm or less, and further preferably 3 mm or less.

This preferred embodiment is a 3^{rd} embodiment of the invention, that preferably depends on any of the 1^{st} to 2^{nd} embodiments of the invention.

In an aspect of the 3^{rd} embodiment, all possible combinations of the features a. and b. are preferred aspects of the embodiment. These combinations are e.g., a; b; a+b. The 3^{rd} embodiment, feature a., should be understood to apply to receptacles, of the first plurality of receptacles, that are in contact with the protrusions of the further plurality of receptacles. The 3^{rd} embodiment, feature b., should be understood to apply to receptacles, of the further plurality of receptacles, that are in contact with the protrusions of the first plurality of receptacles.

In a preferred embodiment of the first structure, an average length of the protrusions, of the first plurality of receptacles, is less than an average maximum length of the receptacles, of the first plurality of receptacles.

This preferred embodiment is a 4th embodiment of the invention, that preferably depends on any of the 1^{st} to 3^{rd} embodiments of the invention.

In a preferred embodiment of the first structure, a ratio of the average length of the protrusions, of the first plurality of receptacles, to the average maximum length of the receptacles, of the first plurality of receptacles, is in the range from 0.05 to 1, preferably from 0.3 to 1, more preferably from 0.55 to 0.99, and further preferably from 0.85 to 0.98.

This preferred embodiment is a 5^{th} embodiment of the invention, that preferably depends on any of the 1^{st} to 4^{th} embodiments of the invention.

In a preferred aspect of the 5^{th} embodiment, the ratio of the average length of the protrusions, of the first plurality of receptacles, to the average maximum length of the receptacles, of the first plurality of receptacles, is in the range from 0.2 to 1, more preferably from 0.4 to 1, even more preferably from 0.6 to 1, and further preferably from 0.8 to 1.

In a preferred embodiment of the first structure, the average length of the protrusions, of the first plurality of receptacles, is in the range from 10 to 90 mm, preferably from 13 to 80 mm, even more preferably from 15 to 70 mm, and further preferably from 17 to 60 mm.

This preferred embodiment is a 6^{th} embodiment of the invention, that preferably depends on any of the 1^{st} to 5^{th} embodiments of the invention.

In a preferred embodiment of the first structure, each receptacle, of the first plurality of receptacles, comprises at least one protrusion extending into the interior of said receptacle, wherein
I. the at least one protrusion has a first end, and
II. a first distance between the first end of the respective receptacle and the first end of the protrusion is larger than zero, wherein said first distance is measured parallel to a maximum length of the respective receptacle.

This preferred embodiment is a 7^{th} embodiment of the invention, that preferably depends on any of the 1^{st} to 6^{th} embodiments of the invention.

In a preferred embodiment of the first structure, a ratio of the first distance to the maximum length of the respective receptacle is in the range from 0 to 0.9, preferably from 0 to 0.6, more preferably from 0 to 0.3, further preferably from 0 to 0.15, and even further preferably from 0 to 0.05.

This preferred embodiment is an 8^{th} embodiment of the invention, that preferably depends on the 7^{th} embodiment of the invention.

In a preferred embodiment of the first structure, the first distance is in the range from 0 to 110 mm, preferably from 0 to 70 mm, more preferably from 0 to 30 mm, even more preferably from 0 to 15 mm, and further preferably from 0 to 5 mm.

This preferred embodiment is a 9^{th} embodiment of the invention, that preferably depends on any of the 7^{th} to 8^{th} embodiments of the invention.

In a preferred aspect of the 9^{th} embodiment, the first distance is in the range from 0 to 50 mm, more preferably from 0 to 40 mm, even more preferably from 0 to 10 mm, and further preferably from 0 to 3 mm.

In a preferred embodiment of the first structure, each receptacle, of the first plurality of receptacles, comprises at least one protrusion extending into the interior of said receptacle, wherein
I. the at least one protrusion comprises at least one vertex, preferably formed by at least two planes of the at least one protrusion, and
II. a second distance between the first end of the receptacle and the at least one vertex is larger than zero, wherein said second distance is measured parallel to a maximum length of the respective receptacle.

This preferred embodiment is a 10^{th} embodiment of the invention, that preferably depends on any of the 1^{st} to 9^{th} embodiments of the invention.

In a preferred embodiment of the first structure, a ratio of the second distance to the maximum length of the respective receptacle is in the range from 0.005 to 0.75, preferably from 0.01 to 0.55, more preferably from 0.03 to 0.35, even more preferably from 0.04 to 0.2, and further preferably from 0.05 to 0.1.

This preferred embodiment is a 11^{th} embodiment of the invention, that preferably depends on the 10^{th} embodiment of the invention.

In a preferred embodiment of the first structure, the second distance is in the range from 0.5 to 10 mm, preferably from 1 to 8 mm, more preferably from 2 to 6 mm, and further preferably from 3 to 4 mm.

This preferred embodiment is a 12^{th} embodiment of the invention, that preferably depends on any of the 10^{th} to 11^{th} embodiments of the invention.

In a preferred embodiment of the first structure, the following applies for each receptacle, of the first plurality of receptacles:
I. the at least one protrusion has a maximum extension point defined as a point on the at least one protrusion that is furthest from the sidewall of the respective receptacle, and
II. a third distance between the first end of the receptacle and the maximum extension point is larger than zero, wherein said third distance is measured parallel to the maximum length of the receptacle.

This preferred embodiment is a 13^{th} embodiment of the invention, that preferably depends on any of the 1^{st} to 12^{th} embodiments of the invention.

In the 13^{th} embodiment, the third distance is measured perpendicular to the sidewall on which the protrusion is arranged.

In a preferred embodiment of the first structure, a ratio of the third distance to the maximum length of the respective receptacle is at least 0.1, preferably at least 0.25, more preferably at least 0.35, and further preferably at least 0.45.

This preferred embodiment is a 14^{th} embodiment of the invention, that preferably depends on the 13^{th} embodiment of the invention.

In a preferred embodiment of the first structure, the first plurality of receptacles are adapted and arranged such that at least one or all of the following applies when the first structure is arranged in contact with the further structure:
a. 30% or less, preferably 20% or less, even more preferably 10% or less, further preferably 5% or less, and even further preferably 3% or less of a minimum length of the first plurality of receptacles, of the first structure, is located in the further plurality of receptacles of the further structure, and/or
b. 30% or less, preferably 20% or less, even more preferably 10% or less, further preferably 5% or less, and even further 3% or less of a minimum length of the further plurality of receptacles, of the further structure, is located in the first plurality of receptacles of the first structure.

This preferred embodiment is a 15^{th} embodiment of the invention, that preferably depends on any of the 1^{st} to 14^{th} embodiments of the invention.

In an aspect of the 15^{th} embodiment, all possible combinations of the features a. and b. are preferred aspects of the embodiment. These combinations are e.g., a; b; a+b.

In a preferred embodiment of the first structure, the first plurality of receptacles are adapted and arranged such that at least one or all of the following applies when the first structure is arranged in contact with the further structure:
a. the length of the sidewalls of the first plurality of receptacles, of the first structure, that is located in the further plurality of receptacles of the further structure is 10 mm or less, preferably 7 mm or less, more preferably 5 mm or less, and further preferably 3 mm or less;
b. the length of the sidewalls of the further plurality of receptacles, of the further structure, that is located in the first plurality of receptacles of the first structure is 10 mm or less, preferably 7 mm or less, more preferably 5 mm or less, and further preferably 3 mm or less.

This preferred embodiment is a 16^{th} embodiment of the invention, that preferably depends on any of the 1^{st} to 15^{th} embodiments of the invention.

In an aspect of the 16^{th} embodiment, all possible combinations of the features a. and b. are preferred aspects of the embodiment. These combinations are e.g., a; b; a+b.

In a preferred embodiment of the first structure, the first plurality of receptacles are adapted and arranged such that at least one or all of the following applies when the first structure is arranged in contact with the further structure:
a. 30% or less, preferably 20% or less, and further preferably 10% or less of outer surfaces of the sidewalls of the receptacles, of the first plurality of receptacles, are in contact with inner surfaces of the sidewalls of the receptacles, of the further plurality of receptacles; and/or
b. 30% or less, preferably 20% or less, and further preferably 10% or less of outer surfaces of the sidewalls of the receptacles, of the further plurality of receptacles, are in contact with inner surfaces of the sidewalls of the receptacles, of the first plurality of receptacles,
wherein an inner surface of a sidewall of a receptacle faces the interior of said receptacles, and an outer surface of a sidewall of the receptacle is opposite the inner surface of said sidewall.

This preferred embodiment is a 17^{th} embodiment of the invention, that preferably depends on any of the 1^{st} to 16^{th} embodiments of the invention.

In an aspect of the 17^{th} embodiment, all possible combinations of the features a. and b. are preferred aspects of the embodiment. These combinations are e.g., a; b; a+b.

In a preferred embodiment of the first structure, the first structure further comprises a first component that at least partially surrounds, preferably surrounds, the first plurality of receptacles, wherein
i. the first component has a first face and a further face, opposite the first face,
ii. the first face is directed towards the first ends of the first plurality of receptacles, and
iii. the further face is directed towards the further ends of the first plurality of receptacles;
and wherein
   the first structure comprises at least one raised section that extends above the first face of the first component.

This preferred embodiment is an 18^{th} embodiment of the invention, that preferably depends on any of the 1^{st} to 17^{th} embodiments of the invention.

In a preferred aspect of the 18^{th} embodiment, the first component is arranged between the first ends and the further ends of the first plurality of receptacles (e.g., not flush with either the first ends or the further ends). In a preferred aspect of the 18^{th} embodiment, the first component is arranged perpendicular to a maximum length of the first plurality of receptacles. In a preferred aspect of the 18^{th} embodiment, the first component is planar.

In a preferred embodiment of the first structure, the first structure further comprises a first component that at least partially surrounds, preferably surrounds, the first plurality of receptacles, wherein
i. the first component has a first face and a further face, opposite the first face,
ii. the first face is directed towards the first ends of the first plurality of receptacles, and
iii. the further face is directed towards the further ends of the first plurality of receptacles;
and wherein each receptacle, of the first plurality of receptacles, comprises at least one raised section that extends above the first face of the first component, wherein
A. the at least one raised section at least partially forms a sidewall of the respective receptacle and preferably at least partially forms the first end of the respective receptacle,
B. the first face of the first component faces the first end of the respective receptacle,
C. the first face of the first component faces away from the further end of the respective receptacle.

This preferred embodiment is a 19^{th} embodiment of the invention, that preferably depends on any of the 1^{st} to 18^{th} embodiments of the invention.

In a preferred aspect of the 19^{th} embodiment, the first component is arranged between the first ends and the further ends of the first plurality of receptacles (e.g., not flush with either the first ends or the further ends). In a preferred aspect of the 19^{th} embodiment, the first component is arranged perpendicular to a maximum length of the first plurality of receptacles. In a preferred aspect of the 19^{th} embodiment, the first component is planar.

In a preferred embodiment of the first structure, a height of the raised sections is xL, where L is an average minimum length of the receptacles and x is in the range from 0.005 to 0.5, preferably from 0.03 to 0.35, more preferably from 0.05 to 0.25, and further preferably from 0.1 to 0.2.

This preferred embodiment is a 20^{th} embodiment of the invention, that preferably depends on any of the 18^{th} to 19^{th} embodiments of the invention.

In a preferred embodiment of the first structure, a height of the raised sections is in the range from 0.1 to 8 mm, preferably from 0.5 to 6 mm, more preferably from 1 to 4.5 mm, and further preferably from 2 to 3.5 mm.

This preferred embodiment is a 21^{st} embodiment of the invention, that preferably depends on any of the 18^{th} to 20^{th} embodiments of the invention.

In a preferred embodiment of the first structure, each receptacle, of the first plurality of receptacles, comprises at least one raised section that extends around at least 15%, preferably at least 25%, more preferably at least 40%, even more preferably at least 50%, and further preferably at least 60% of a circumference of the respective receptacle.

This preferred embodiment is a 22^{nd} embodiment of the invention, that preferably depends on any of the 18^{th} to 21^{st} embodiments of the invention.

The 22^{nd} embodiment should be understood to mean that each receptacle, of the first plurality of receptacles, comprises at least one raised section that extends around at least 15%, preferably at least 25%, more preferably at least 40%, even more preferably at least 50%, and further preferably at least 60% of a circumference of the respective receptacle. In the 22^{nd} embodiment, if a receptacle of the first plurality of receptacles comprise multiple raised sections, this should preferably be understood to mean that the multiple raised sections together extend around at least 15%, preferably at least 25%, more preferably at least 40%, even more preferably at least 50%, and further preferably at least 60% of a circumference of the respective receptacle (e.g., not each raised section extends around 15% of the circumference).

In a preferred embodiment of the first structure, at least one or all of the following applies:
a. the at least one raised section has a non-uniform height;
b. the at least one raised section is planar.

This preferred embodiment is a 23^{rd} embodiment of the invention, that preferably depends on any of the 18^{th} to 22^{nd} embodiments of the invention.

In an aspect of the 23^{rd} embodiment, all possible combinations of the features a. and b. are preferred aspects of the embodiment. These combinations are e.g., a; b; a+b.

In a preferred embodiment of the first structure, the first end of each receptacle, of the first plurality of receptacles, comprises at least one recess, preferably at least two recesses, and further preferably at least three recesses.

This preferred embodiment is a 24^{th} embodiment of the invention, that preferably depends on any of the 1^{st} to 23^{rd} embodiments of the invention.

In a preferred embodiment of the first structure, at least one or all of the following applies:
a. a depth of the at least one recess, of the first ends of the first plurality of receptacles, is in the range from >0 to 35 mm, preferably from 0.5 to 25 mm, more preferably from 1 to 15 mm, and further preferably from 3 to 7 mm;
b. a width of the at least one recess, of the first ends of the first plurality of receptacles, is in the range from >0 to 35 mm, preferably from 0.5 to 30 mm, more preferably from 1 to 25 mm, and further preferably from 5 to 20 mm.

This preferred embodiment is a 25^{th} embodiment of the invention, that preferably depends on the 24^{th} embodiments of the invention.

In an aspect of the 25^{th} embodiment, all possible combinations of the features a. and b. are preferred aspects of the embodiment. These combinations are e.g., a; b; a+b. In a preferred aspect of the 25^{th} embodiment, feature a., the at least one recess has a depth that is in the range from >0 to 18 mm, preferably from 0.5 to 15 mm, more preferably from 1 to 12 mm, and further preferably from 5 to 10 mm.

In a preferred embodiment of the first structure, the further end of each receptacle, of the first plurality of receptacles, comprises at least one recess, preferably at least two recesses, and more preferably at least three recesses.

This preferred embodiment is a 26^{th} embodiment of the invention, that preferably depends on any of the 1^{st} to 25^{th} embodiments of the invention.

In a preferred aspect of the 26^{th} embodiment, the at least one recess is adapted and arranged to detachably engage at least one raised section of the further structure, preferably at least one raised section of a first end of a receptacle of the further plurality of receptacles, of the further structure.

In a preferred embodiment of the first structure, at least one or all of the following applies:
a. a depth of the at least one recess, of the further ends of the first plurality of receptacles, is in the range from 0.1 to 8 mm, preferably from 0.5 to 6 mm, more preferably from 1 to 4.5 mm, and further preferably from 2 to 3.5 mm;
b. a width of the at least one recess, of the further ends of the first plurality of receptacles, is in the range from 0.5 to 12 mm, preferably from 1 to 10 mm, more preferably from 2 to 9 mm, and further preferably from 3 to 8 mm.

This preferred embodiment is a 27^{th} embodiment of the invention, that preferably depends on the 26^{th} embodiments of the invention.

In an aspect of the 27^{th} embodiment, all possible combinations of the features a. and b. are preferred aspects of the embodiment. These combinations are e.g., a; b; a+b.

In a preferred embodiment of the first structure, the first structure comprises at least one projection that extends above the first face of the first component.

This preferred embodiment is a 28^{th} embodiment of the invention, that preferably depends on any of the 1^{st} to 27^{th} embodiments of the invention.

In a preferred aspect of the 28^{th} embodiment, the at least one projection is arranged perpendicular to the first component. In a preferred aspect of the 28^{th} embodiment, the at least one projection is adapted and arranged to detachably engage with at least one recess when the first structure is in contact with the further structure. In this aspect, the at least one recess preferably forms part of a sidewall of a receptacle of the further structure. In this aspect, the receptacle may be any receptacle of the further structure (i.e., not necessarily a receptacle of the further plurality of receptacles).

In a preferred embodiment of the first structure, at least one or all of the following applies:
a. the at least one projection has a height that is in the range from 0.1 to 8 mm, preferably from 0.5 to 6 mm, more preferably from 1 to 4.5 mm, and further preferably from 2 to 3.5 mm;
b. the at least one projection has a maximum perpendicular dimension, measured perpendicular to the height of the at least one projection, that is in the range from 0.5 to 10 mm.

This preferred embodiment is a 29^{th} embodiment of the invention, that preferably depends on the 28^{th} embodiments of the invention.

In an aspect of the 29^{th} embodiment, all possible combinations of the features a. and b. are preferred aspects of the embodiment. These combinations are e.g., a; b; a+b.

A 30^{th} embodiment of the invention is an arrangement comprising a first structure A according to the invention and a further structure B, preferably configured in the same manner as the first structure A, wherein
a. the first structure A comprises
   i. a first plurality of receptacles A, wherein the receptacles A of the first plurality of receptacles
      A. have first ends A and further ends A,
      B. comprise sidewalls A at least partially enclosing, preferably enclosing, interiors A of the receptacles A,
      C. comprise protrusions A that extend into the interiors A of the receptacles A;
b. the further structure B comprises
   i. a further plurality of receptacles B, wherein the receptacles B of the further plurality of receptacles
      A. have first ends B and further ends B,
      B. comprise sidewalls B at least partially enclosing, preferably enclosing, interiors B of the receptacles B,
      C. comprise protrusions B that extend into the interiors B of the receptacles B;
wherein
   the structure B is arranged in contact with the structure A such that at least one or all of the following applies:
      I. 30% or less, preferably 20% or less, more preferably 10% or less, and further preferably 5% or less of the receptacles A are in contact with the protrusions B, and/or
      II. 30% or less, preferably 20% or less, more preferably 10% or less, and further preferably 5% or less of the receptacles B are in contact with the protrusions A.

In a preferred aspect of the 30^{th} embodiment, the first structure A is preferably a first structure according to any of 1^{st} to 29^{th} embodiments of the invention. In a preferred aspect of the 30^{th} embodiment, the further structure B is preferably configured in the same manner as a first structure according to the invention, and more preferably a first structure according to any of 1^{st} to 29^{th} embodiments of the invention. In an aspect of the 30^{th} embodiment, all possible combinations of the features I. and II. are preferred aspects of the embodiment. These combinations are e.g., I; II; I+II. In a preferred aspect of the 30^{th} embodiment, the further ends A are in contact with at least one section of the sidewalls B, preferably the first ends B. In a preferred aspect of the 30^{th} embodiment, the further ends B are in contact with at least one section of the sidewalls A, preferably the first ends A. In a preferred aspect of the 30^{th} embodiment, the first structure A and the further structure B are in contact such that the first structure A and the further structure B are detachably engaged. In the 30^{th} embodiment, a preferred form of contact between the first structure A and the further structure B includes the following: the first structure A is stacked onto and/or in the further structure B, the further structure B is stacked onto and/or in the first structure A.

In a preferred embodiment of the arrangement, at least one or all of the following applies:
a. 20% or less, preferably 15% or less, more preferably 10% or less, and further preferably 5% or less of a maximum length of the receptacles A are in contact with the protrusions B;
b. 20% or less, preferably 15% or less, more preferably 10% or less, and further preferably 5% or less of a maximum length of the receptacles B are in contact with the protrusions A.

This preferred embodiment is a 31^{st} embodiment of the invention, that preferably depends on the 30^{th} embodiment of the invention.

In an aspect of the 31^{st} embodiment, all possible combinations of the features a. and b. are preferred aspects of the embodiment. These combinations are e.g., a; b; a+b. The 31^{st} embodiment, feature a., should be understood to apply to receptacles A that are in contact with the protrusions B. The 31^{st} embodiment, feature b., should be understood to apply to receptacles B that are in contact with the protrusions A.

In a preferred embodiment of the arrangement, at least one or all of the following applies:
a. a length of the sidewalls of the receptacles A that are in contact with the protrusions B is 10 mm or less, preferably 7 mm or less, more preferably 5 mm or less, and further preferably 3 mm or less;
b. the length of the sidewalls of the receptacles B that are in contact with the protrusions A is 10 mm or less, preferably 7 mm or less, more preferably 5 mm or less, and further preferably 3 mm or less.

This preferred embodiment is a 32^{nd} embodiment of the invention, that preferably depends on any of the 30^{th} to 31^{st} embodiments of the invention.

In an aspect of the 32^{nd} embodiment, all possible combinations of the features a. and b. are preferred aspects of the embodiment. These combinations are e.g., a; b; a+b. The 32^{nd} embodiment, feature a., should be understood to apply to each receptacle A that is in contact with the protrusions B. The 32^{nd} embodiment, feature b., should be understood to apply to each receptacles B that is in contact with the protrusions A.

In a preferred embodiment of the arrangement, at least one or all of the following applies:
a. the average length of the protrusions A is less than an average maximum length of the first plurality of receptacles A;
b. the average length of the protrusions B is less than an average maximum length of the further plurality of receptacles B.

This preferred embodiment is a 33^{rd} embodiment of the invention, that preferably depends on any of the 30^{th} to 32^{nd} embodiments of the invention.

In an aspect of the 33^{rd} embodiment, all possible combinations of the features a. and b. are preferred aspects of the embodiment. These combinations are e.g., a; b; a+b.

In a preferred embodiment of the arrangement, at least one or all of the following applies:
a. the ratio of the average length of the protrusions A to the average maximum length of the receptacles A is in the range from 0.05 to 1, preferably from 0.3 to 1, more preferably from 0.55 to 0.99, and further preferably from 0.85 to 0.98;
b. the ratio of the average length of the protrusions B to the average maximum length of the receptacles B is in the range from 0.05 to 1, preferably from 0.3 to 1, more preferably from 0.55 to 0.99, and further preferably from 0.85 to 0.98.

This preferred embodiment is a 34^{th} embodiment of the invention, that preferably depends on any of the 30^{th} to 33^{rd} embodiments of the invention.

In an aspect of the 34^{th} embodiment, all possible combinations of the features a. and b. are preferred aspects of the embodiment. These combinations are e.g., a; b; a+b. In a preferred aspect of the 34^{th} embodiment, the ratio of the average length of the protrusions A to the average maximum length of the receptacles A is in the range from 0.2 to 1, more preferably from 0.4 to 1, even more preferably from 0.6 to 1, and further preferably from 0.8 to 1. In a preferred aspect of the 34^{th} embodiment, the ratio of the average length of the protrusions B to the average maximum length of the receptacles B is in the range from 0.2 to 1, more preferably from 0.4 to 1, even more preferably from 0.6 to 1, and further preferably from 0.8 to 1.

In a preferred embodiment of the arrangement, at least one or all of the following applies:
a. the average length of the protrusions A is in the range from 10 to 90 mm, preferably from 13 to 80 mm, even more preferably from 15 to 70 mm, and further preferably from 17 to 60 mm;
b. the average length of the protrusions B is in the range from 10 to 90 mm, preferably from 13 to 80 mm, even more preferably from 15 to 70 mm, and further preferably from 17 to 60 mm.

This preferred embodiment is a 35^{th} embodiment of the invention, that preferably depends on any of the 30^{th} to 34^{th} embodiments of the invention.

In an aspect of the 35^{th} embodiment, all possible combinations of the features a. and b. are preferred aspects of the embodiment. These combinations are e.g., a; b; a+b.

In a preferred embodiment of the arrangement, at least one or all of the following applies:
a. the following applies for the receptacles A:
   I. the protrusions A have first ends, and
   II. a first average distance A between the first ends A of the receptacles A and the first ends of the protrusions A is larger than zero, wherein said first average distance A is measured parallel to the maximum length of the receptacles A;
b. the following applies for the receptacles B:
   I. the protrusions B have first ends, and
   II. a first average distance B between the first ends B of the receptacles B and the first ends of the protrusions B is larger than zero, wherein said first average distance B is measured parallel to the maximum length of the receptacles B.

This preferred embodiment is a 36^{th} embodiment of the invention, that preferably depends on any of the 30^{th} to 35^{th} embodiments of the invention.

In an aspect of the 36^{th} embodiment, all possible combinations of the features a. and b. are preferred aspects of the embodiment. These combinations are e.g., a; b; a+b.

In a preferred embodiment of the arrangement, at least one or all of the following applies:
a. a ratio of the first average distance A to the average maximum length of the receptacles A is in the range from 0 to 0.9, preferably from 0 to 0.6, more preferably from 0 to 0.3, further preferably from 0 to 0.15, and even further preferably from 0 to 0.05;
b. a ratio of the first average distance B to the average maximum length of the receptacles B is in the range from 0 to 0.9, preferably from 0 to 0.6, more preferably from 0 to 0.3, further preferably from 0 to 0.15, and even further preferably from 0 to 0.05.

This preferred embodiment is a 37^{th} embodiment of the invention, that preferably depends on the 36^{th} embodiment of the invention.

In an aspect of the 37^{th} embodiment, all possible combinations of the features a. and b. are preferred aspects of the embodiment. These combinations are e.g., a; b; a+b.

In a preferred embodiment of the arrangement, at least one or all of the following applies:
a. the first average distance A is in the range from 0 to 110 mm, preferably from 0 to 70 mm, more preferably from 0 to 30 mm, even more preferably from 0 to 15 mm, and further preferably from 0 to 5 mm;
b. the first average distance B is in the range from 0 to 110 mm, preferably from 0 to 70 mm, more preferably from 0 to 30 mm, even more preferably from 0 to 15 mm, and further preferably from 0 to 5 mm.

This preferred embodiment is a 38^{th} embodiment of the invention, that preferably depends on any of the 36^{th} to 37^{th} embodiments of the invention.

In an aspect of the 38^{th} embodiment, all possible combinations of the features a. and b. are preferred aspects of the embodiment. These combinations are e.g., a; b; a+b. In a preferred aspect of the 38^{th} embodiment, feature a., the first average distance A is in the range from 0 to 50 mm, more preferably from 0 to 40 mm, even more preferably from 0 to 10 mm, and further preferably from 0 to 3 mm. In a preferred aspect of the 38^{th} embodiment, feature b., the first average distance B is in the range from 0 to 50 mm, more preferably from 0 to 40 mm, even more preferably from 0 to 10 mm, and further preferably from 0 to 3 mm.

In a preferred embodiment of the arrangement, at least one or all of the following applies:
a. the following applies for the receptacles A:
   I. the protrusions A have first ends and vertices A, and
   II. a second average distance A between the first ends A of the receptacles A and the vertices A is larger than zero, wherein said second average distance A is measured parallel to the maximum length of the receptacles A;
b. the following applies for the receptacles B:
   I. the protrusions B have first ends and vertices B, and
   II. a second average distance B between the first ends B of the receptacles B and the vertices B is larger than zero, wherein said second average distance B is measured parallel to the maximum length of the receptacles B.

This preferred embodiment is a 39^{th} embodiment of the invention, that preferably depends on any of the 30^{th} to 38^{th} embodiments of the invention.

In an aspect of the 39^{th} embodiment, all possible combinations of the features a. and b. are preferred aspects of the embodiment. These combinations are e.g., a; b; a+b.

In a preferred embodiment of the arrangement, at least one or all of the following applies:
a. a ratio of the second average distance A to the average maximum length of the receptacles A is in the range from 0.005 to 0.75, preferably from 0.01 to 0.55, more preferably from 0.03 to 0.35, even more preferably from 0.04 to 0.2, and further preferably from 0.05 to 0.1;
b. a ratio of the second average distance B to the average maximum length of the receptacles B is in the range from 0.005 to 0.75, preferably from 0.01 to 0.55, more preferably from 0.03 to 0.35, even more preferably from 0.04 to 0.2, and further preferably from 0.05 to 0.1.

This preferred embodiment is a 40^{th} embodiment of the invention, that preferably depends on the 39^{th} embodiment of the invention.

In an aspect of the 40^{th} embodiment, all possible combinations of the features a. and b. are preferred aspects of the embodiment. These combinations are e.g., a; b; a+b.

In a preferred embodiment of the arrangement, at least one or all of the following applies:
a. the second average distance A is in the range from 0.5 to 10 mm, preferably from 1 to 8 mm, more preferably from 2 to 6 mm, and further preferably from 3 to 4 mm;
b. the second average distance B is in the range from 0.5 to 10 mm, preferably from 1 to 8 mm, more preferably from 2 to 6 mm, and further preferably from 3 to 4 mm.

This preferred embodiment is a 41^{st} embodiment of the invention, that preferably depends on any of the 39^{th} to 40^{th} embodiments of the invention.

In an aspect of the 41^{st} embodiment, all possible combinations of the features a. and b. are preferred aspects of the embodiment. These combinations are e.g., a; b; a+b.

A 42^{nd} embodiment of the invention is a method for processing at least two structures, comprising the steps of
a. providing a first structure A according to the invention and a further structure B, preferably configured in the same manner as the first structure A, wherein
   i. the first structure A comprises a first plurality of receptacles A, wherein the receptacles A of the first plurality of receptacles
      A. have first ends A and further ends A,
      B. comprise sidewalls A at least partially enclosing, preferably enclosing, interiors A of the receptacles A,
      C. comprise protrusions A that extend into the interiors A of the receptacles A;
   ii. the further structure B comprises a further plurality of receptacles B, wherein the receptacles B of the further plurality of receptacles
      A. have first ends B and further ends B,
      B. comprise sidewalls B at least partially enclosing, preferably enclosing, interiors B of the receptacles B,
      C. comprise protrusions B that extend into the interiors B of the receptacles B;
b. arranging the first structure A to be in contact with the further structure B such that
   I. 30% or less, preferably 20% or less, more preferably 10% or less, and further preferably 5% or less of the receptacles A are in contact with the protrusions B, and/or
   II. 30% or less, preferably 20% or less, more preferably 10% or less, and further preferably 5% or less of the receptacles B are in contact with the protrusions A.

In a preferred aspect of the 42^{nd} embodiment, the first structure A is preferably a first structure according to any of 1^{st} to 29^{th} embodiments of the invention. In a preferred aspect of the 42^{nd} embodiment, the further structure B is preferably configured in the same manner as a first structure according to the invention, and more preferably a first structure according to any of 1^{st} to 29^{th} embodiments of the invention. In an aspect of the 42^{nd} embodiment, all possible combinations of the features I. and II. are preferred aspects of the embodiment. These combinations are e.g., I; II; I+II. In a preferred aspect of the 42^{nd} embodiment, the further ends A are arranged in contact with at least one section of the sidewalls B, preferably the first ends B. In a preferred aspect of the 42^{nd} embodiment, the further ends B are arranged in contact with at least one section of the sidewalls A, preferably the first ends A. In a preferred aspect of the 42^{nd} embodiment, the first structure A and the further structure B are arranged to be in contact with each other to obtain an arrangement according to any of the 30^{th} to 41^{st} embodiments of the invention.

In a preferred embodiment of the method for processing at least two structures, the processing includes at least one or all of the following: stacking, storing, transporting.

This preferred embodiment is a 43^{rd} embodiment of the invention, that preferably depends on the 42^{nd} embodiment of the invention.

In a preferred embodiment of the method for processing at least two structures, the method further comprises the following steps:
a. separating the first structure A and the first structure B;
b. inserting a plurality of containers into the first plurality of receptacles A;
c. preferably reducing a temperature of the first structure A and the containers accommodated therein, more preferably to be below 0° C.

This preferred embodiment is a 44^{th} embodiment of the invention, that preferably depends on any of the 42^{nd} to 43^{rd} embodiment of the invention.

A 45^{th} embodiment of the invention is a use of a first structure according to the invention, preferably the first structure according to any of the 1^{st} to 29^{th} embodiments of the invention, for at least one or all of the following:
a. to reduce a force necessary for removing the first structure and a further structure from each other when said first structure is in contact with the further structure;
b. to reduce contact between the receptacles of the first structure and protrusions of a further structure, with said protrusions extending into the interiors of receptacles of the further structure and/or to reduce contact between the receptacles of the further structure and protrusions of the first structure, with said protrusions extending into the interiors of receptacles of the first structure, when the first structure and the further structure are in contact;
c. to reduce a particle formation on the first structure when said first structure is in contact with a further structure;
d. to reduce contact of the sidewalls of the first structure with a further structure and/or to reduce contact of the sidewalls of the further structure with the first structure when said first structure and further structure are in contact;
e. for reducing a movement of the first structure with respect to a further structure when said first structure and further structure are in contact.

In an aspect of the 45^{th} embodiment, all possible combinations of the features a. to e. are preferred aspects of the embodiment. These combinations are e.g., a; b; c; d; e; a+b; a+c; a+d; a+e; b+c; b+d; b+e; c+d; c+e; d+e; a+b+c; a+b+d; a+b+e; a+c+d; a+c+e; a+d+e; b+c+d; b+c+e; b+d+e; c+d+e; a+b+c+d; a+b+c+e; a+b+d+e; a+c+d+e; b+c+d+e; a+b+c+d+e. In a preferred aspect of the 45^{th} embodiment, feature a., reducing a force reduces the warpage. In a preferred aspect of the 45^{th} embodiment, feature e., examples of a horizontal movement include a translational movement and a rotational movement.

A 46^{th} embodiment of the invention is a use of a first structure according to the invention, preferably the first structure according to any of the 1^{st} to 29^{th} embodiments of the invention, for accommodating at least one container, wherein said at least one container is for accommodating a pharmaceutical, medical and/or cosmetic composition.

Features described as preferred in one category of the invention, for example according to the first structure, are analogously preferred in an embodiment of the other categories according to the invention, such as a use of the first structure according to the invention.

Throughout this document, disclosures of ranges should preferably be understood to include both end points of the range. Furthermore, each disclosure of a range in the document should preferably be understood as also disclosing preferred sub-ranges in which one end point is excluded or both end points are excluded. For example, a disclosure of a range from X₁ to X₂ is to be understood as disclosing a range that includes both end points X₁ and X₂. Further-more, it is to be understood as also disclosing a range that includes the end point X₁ but excludes the end point X₂, a range that excludes the end point X₁ but includes the end point X₂, and a range that excludes both end points X₁ and X₂.

Some preferred embodiments and preferred aspects have various combinations of features as alternatives. If the various combinations are disclosed, these combinations are separated by a semi-colon (“;”). For example, the list of features “a; a+b; a+c+d” for a preferred embodiment discloses a preferred embodiment that comprises the feature “a”, a preferred embodiment that comprises the features “a” and “b”, and a preferred embodiment that comprises the features “a”, “c”, and “d”.

### Structure

Examples of a structure are a first structure and a further structure. A structure preferably comprises a polymer. Examples of a preferred polymer include polypropylene, polyoxymethylene, polyethylene, polyethylene terephthalate, polystyrene, a cyclic olefin copolymer (COC) and a cyclic olefin polymer (COP). Here polypropylene is particularly preferred for the structure.

A structure may be obtained using deep drawing, moulding, preferably injection moulding, and/or 3D printing. A structure is preferably manufactured as a single piece. A structure with receptacles for accommodating containers, wherein said containers in turn are for accommodating pharmaceutical, medical and/or cosmetic compositions, is often referred to as a “nest”. Here “nest” should preferably be understood as used in the pharmaceutical industry.

A structure preferably comprises a total number of 5 to 250, more preferably 10 to 200, even more preferably 20 to 190, further preferably 40 to 180, further preferably 60 to 180, further preferably 80 to 180, and even further preferably 100 to 160, receptacles. Here the total number refers to all receptacles of the first structure that are adapted and arranged to accommodate a container (e.g., comprising the first plurality of receptacles and any other pluralities of receptacles, if present).

In one preferred aspect of the invention, the first plurality of receptacles has in the range from 2 to 200, more preferably from 4 to 180, and further preferably from 6 to 160 receptacles.

In a preferred aspect of the invention, a structure is adapted and arranged to be thermally stable down to temperatures of at least −80° C., more preferably down to temperatures of at least −70° C., and further preferably down to temperatures of at least −50° C. Here thermally stable should preferably be understood to mean that the structure is not damaged when subjected to temperatures below 0° C.

A further structure that is configured in the same manner as the first structure should preferably be understood to mean that the further structure comprises the same features as defined for the first structure. For example, a further structure configured in the same manner as the first structure of the 2^{nd} embodiment of the invention should be understood to mean that the further structure has the same features as the first structure, as defined in the 1^{st} and 2^{nd} embodiments of the invention. A further structure that is configured in the same manner as the first structure should also preferably be understood to mean at least one, preferably all, of the following: the first component of the first structure and the further component of the further structure are similar; the first plurality of receptacles and the further plurality of receptacles are similar; the first structure and the further structure would be considered by the skilled person as being similar, e.g., the first structure and the further structure have no features that allows for distinguishing the first structure from the further structure.

In a preferred aspect of the invention, the first structure is adapted and arranged such that when the first structure is arranged in contact with a further structure, a movement of the first structure and the further structure with respect to each other is at least partially constrained in at least one direction, preferably in at least one direction that is parallel to a first component. Here said movement includes at least one or all of the following: a translational movement, a rotational movement, a tilting, or a combination of at least two thereof. In a preferred aspect of the invention, the first structure comprises at least one projection that is adapted and arranged to constrain the movement of the first structure and the further structure with respect to each other.

In a preferred aspect of the invention, the first structure comprises a first component that at least partially surrounds, preferably surrounds, the first plurality of receptacles. In this aspect, it is preferred that an angle α between a normal of the first component and the sidewalls of the first plurality of receptacles is in the range from 0° to 10°, preferably from 0.1 to 7.5°, and further preferably from 0.3° to 5°.

In a preferred embodiment B1 of the invention, the first structure further comprises a second plurality of receptacles, wherein
A. each receptacle of the second plurality of receptacles
   i. is adapted and arranged for accommodating a container, preferably a container for accommodating a pharmaceutical, medical and/or cosmetic composition,
   ii. has a first end and a further end, opposite the first end,
   iii. comprises a sidewall that at least partially encloses, preferably encloses, an interior of the receptacle,
   iv. preferably comprises at least one protrusion extending into the interior of the receptacle, wherein the at least one protrusion is preferably adapted and arranged for a positioning of a container in the receptacle;
B. if present, preferably the first component at least partially surrounds, more preferably surrounds, the second plurality of receptacles;
C. at least one property differs between the receptacles of the first plurality of receptacles and the receptacles of the second plurality of receptacles.

In a preferred aspect of the embodiment B1, the at least one property that differs between the first plurality of receptacles and the second plurality of receptacles includes at least one or all of the following: an average length (maximum and/or minimum), a geometric shape, a depth of at least one recess in the first ends. Here examples of a geometric shape include the following: a diameter of the receptacles of both the first and second pluralities of receptacles decreases from the first ends to the further ends, with said decrease differing between the first plurality and second plurality of receptacles; a cross-sectional shape of the first plurality of receptacles differ from a cross-sectional shape of the second plurality of receptacles.

In a preferred aspect of the invention, one of the following applies:
a. the number of receptacles, of the first plurality of receptacles, is less than the total number of receptacles of the first structure;
b. the number of receptacles, of the first plurality of receptacles, is equal to the total number of receptacles of the first structure.

Here the total number of receptacles include all receptacles (e.g., both the first and the second pluralities of receptacles) of the first structure that are adapted and arranged for accommodating a container.

A first structure according to the invention may have only a first plurality of receptacles. Alternatively, a first structure according to the invention may have both a first plurality of receptacles and a second plurality of receptacles. Alternatively, a first structure according to the invention may have a first plurality of receptacles, a second plurality of receptacles, and one or more additional pluralities of receptacles.

### Receptacle

A preferred receptacle is elongated. A preferred receptacle has a first end and a further end, opposite the first end. A first end of a receptacle preferably has a first opening for receiving a container. In other words, a receptacle is preferably adapted and arranged for a container to be inserted into and/or removed from said respective receptacle at the first end. The further end of a receptacle may be closed or may have a further opening. A further opening at the further end of a receptacle is preferably adapted and arranged to allow a part of a container to extend out of the receptacle when said container is accommodated in the receptacle.

In a preferred aspect of the invention, two or more receptacles of a structure (e.g., the first structure) are adapted and arranged such that sections of sidewalls are shared between said receptacles. For example, a section of a sidewall of a first receptacle forms part of a sidewall of a further receptacle.

In one preferred embodiment of the invention, the first structure has only a first plurality of receptacles. In another preferred embodiment of the invention, the first structure has only a first plurality of receptacles, wherein each receptacle, of the first plurality of receptacles, comprises at least one raised section. In another preferred embodiment of the invention, the first structure comprises a first plurality of receptacles and a second plurality of receptacles, wherein each receptacle, of the first plurality of receptacles, has at least one raised section, and wherein the receptacles, of the second plurality of receptacles, do not have raised sections. In yet another preferred embodiment of the invention, the first structure comprises a first plurality of receptacles and a second plurality of receptacles, wherein each receptacle, of both the first plurality of receptacles and the second plurality of receptacles, has at least one raised section that comprises a recess, wherein a depth of the recesses of the raised sections, of the first plurality of receptacles, differs from a depth of the recesses of the raised sections, of the second plurality of receptacles.

In a preferred embodiment A1 of the invention, the first structure is adapted and arranged such that when the first structure is arranged in contact with a further structure, that at least one or all of the following applies:
I. 20% or less of a maximum length of the receptacles of at least 50%, more preferably at least 75%, and further preferably at least 90% of the receptacles, of the first structure, are in contact with the protrusions of the receptacles of the further structure;
II. 20% or less of a maximum length of the receptacles of at least 50%, more preferably at least 75%, and further preferably at least 90% of the receptacles, of the further structure, are in contact with the protrusions of the receptacles of the first structure.

In an aspect of the embodiment A1, all possible combinations of the features I. and II. are preferred aspects of the embodiment. These combinations are e.g., I; II; I+II.

In a preferred embodiment A2 of the invention, the first structure is adapted and arranged such that when the first structure is arranged in contact with a further structure, that at least one or all of the following applies:
I. 15% or less of a maximum length of the receptacles of at least 50%, more preferably at least 75%, and further preferably at least 90% of the receptacles, of the first structure, are in contact with the protrusions of the receptacles of the further structure;
II. 15% or less of a maximum length of the receptacles of at least 50%, more preferably at least 75%, and further preferably at least 90% of the receptacles, of the further structure, are in contact with the protrusions of the receptacles of the first structure.

In an aspect of the embodiment A2, all possible combinations of the features I. and II. are preferred aspects of the embodiment. These combinations are e.g., I; II; I+II.

In a preferred embodiment A3 of the invention, the first structure is adapted and arranged such that when the first structure is arranged in contact with a further structure, that at least one or all of the following applies:
I. 10% or less of a maximum length of the receptacles of at least 50%, more preferably at least 75%, and further preferably at least 90% of the receptacles, of the first structure, are in contact with the protrusions of the receptacles of the further structure;
II. 10% or less of a maximum length of the receptacles of at least 50%, more preferably at least 75%, and further preferably at least 90% of the receptacles, of the further structure, are in contact with the protrusions of the receptacles of the first structure.

In an aspect of the embodiment A3, all possible combinations of the features I. and II. are preferred aspects of the embodiment. These combinations are e.g., I; II; I+II.

In a preferred embodiment A4 of the invention, the first structure is adapted and arranged such that when the first structure is arranged in contact with a further structure, that at least one or all of the following applies:
I. 5% or less of a maximum length of the receptacles of at least 50%, more preferably at least 75%, and further preferably at least 90% of the receptacles, of the first structure, are in contact with the protrusions of the receptacles of the further structure;
II. 5% or less of a maximum length of the receptacles of at least 50%, more preferably at least 75%, and further preferably at least 90% of the receptacles, of the further structure, are in contact with the protrusions of the receptacles of the first structure.

In an aspect of the embodiment A4, all possible combinations of the features I. and II. are preferred aspects of the embodiment. These combinations are e.g., I; II; I+II.

In a preferred embodiment A5 of the invention, the first structure is adapted and arranged such that when the first structure is arranged in contact with a further structure, that at least one or all of the following applies:
I. 30% or less, preferably 20% or less, more preferably 10% or less, and further preferably 5% or less of the receptacles, of the first structure, are in contact with the protrusions of the receptacles of the further structure, and/or,
II. 30% or less, preferably 20% or less, more preferably 10% or less, and further preferably 5% or less of the receptacles, of the further structure, are in contact with the protrusions of the receptacles of the first structure.

In an aspect of the embodiment A5, all possible combinations of the features I. and II. are preferred aspects of the embodiment. These combinations are e.g., I; II; I+II.

In the preferred embodiments A1 to A5, where reference is made to the “receptacles of the first structure”, this should be understood as including all receptacles of the first structure (e.g., both the first and second pluralities of receptacles if the first structure comprises first and second pluralities of receptacles). In the preferred embodiments A1 to A5, where reference is made to the “receptacles of the further structure”, this should be understood as including all receptacles of the further structure (e.g., both the further and third pluralities of receptacles if the further structure comprises further and third pluralities of receptacles).

Where it is disclosed that X % or less of a minimum length, and/or Y mm or less of a length of the sidewalls, of the first plurality of receptacles (of the first structure) is located in the further plurality of receptacles of the further structure, this feature should be understood to individually apply to each of the receptacles of the first plurality of receptacles. Similarly, where it is disclosed that X % or less of a minimum length, and/or Y mm or less of a length of the sidewalls, of the further plurality of receptacles (of the further structure) is located in the first plurality of receptacles of the first structure, this feature should be understood to individually apply to each of the receptacles of the further plurality of receptacles.

An average maximum length of the receptacles, of the first plurality of receptacles, is determined by measuring the maximum length of each receptacle (of the first plurality of receptacles) and calculating an average from these measurements. An average minimum length of the receptacles, of the first plurality of receptacles, is determined by measuring the minimum length of each receptacle (of the first plurality of receptacles) and calculating an average from these measurements.

### Raised Section

A raised section preferably at least partially, more preferably partially, forms part of a sidewall of a receptacle. A raised section may also partially form the sidewall of more than one receptacle.

In one preferred aspect of the invention, the first structure comprises a first plurality of receptacles and a second plurality of receptacles, wherein a first end of each receptacle, of both the first and second pluralities of receptacles, comprises at least a recess, and wherein a first depth of the recesses of the first plurality of receptacles differs from a second depth of the recesses of the second plurality of receptacles. In this aspect, it is preferred that the first depth is less than the second depth. In this aspect, it is preferred that the first depth is in the range from >0 to 18 mm, more preferably from 0.5 to 15 mm, even more preferably from 1 to 12 mm, and further preferably from 5 to 10 mm. In this aspect, it is preferred that the second depth is in the range from >0 to 35 mm, more preferably from 0.5 to 30 mm, even more preferably from 1 to 25 mm, and further preferably from 5 to 20 mm.

In a preferred embodiment of the invention, each receptacle, of the first plurality of receptacles, comprises at least one raised section extends around at least X % of a circumference of the respective receptacle. If a receptacle, of the first plurality of receptacles, comprise multiple raised sections, this should preferably be understood to mean that the multiple raised sections collectively extend around at least X % of the circumference of the respective receptacle (e.g., each raised section does not individually extend around X % of the circumference).

Where it is disclosed that the raised section has a height of xL and/or in the range from Z₁ to Z₂ mm, this should be understood to mean that each of the raised sections individually has a height of xL and/or a height in the range from Z₁ to Z₂.

### Protrusion

A protrusion is preferably adapted and arranged for positioning a container in a receptacle. In a preferred aspect of the invention, a protrusion is adapted and arranged for at least one or all of the following: positioning a container during insertion of said container into a receptacle, and/or positioning a container during removal of said container from a receptacle, and/or positioning a container when said container is accommodated in a receptacle.

A protrusion preferably comprises, more preferably is made of, at least one thermoplastic. A protrusion may have any geometric shape. In a preferred aspect of the invention, one or more protrusions of a receptacle are formed as ribs. In a preferred aspect of the invention, a protrusion is formed as one piece with the sidewall of a receptacle. In a preferred aspect of the invention, a protrusion extends in a direction that is substantially perpendicular to the sidewall of the receptacle. In one preferred aspect of the invention, a protrusion and the sidewall, on which said protrusion is arranged, is made from the same material. In another preferred aspect of the invention, a protrusion and the sidewall, on which said protrusion is arranged, are made from different materials.

A vertex of a protrusion is formed by at least two planes of said protrusion. Here vertex should be understood broadly. For example, it is not required that a vertex be formed as a sharp edge but may also be rounded.

An average length of the protrusion, of the first plurality of receptacles, is determined by measuring the lengths of all protrusions (of the first plurality of receptacles) and calculating an average from these measurements.

A first average distance of a plurality of receptacles (e.g., the first plurality, the further plurality) is determined by measuring the first distances for all protrusions, of the plurality of receptacles, and calculating an average from these measurements. A second average distance of a plurality of receptacles (e.g., the first plurality, the further plurality) is determined by measuring the second distances for all protrusions, of the plurality of receptacles, and calculating an average from these measurements.

### Projection

A projection preferably comprises, more preferably is made of, at least one thermoplastic. In a preferred aspect of the invention, a projection is formed as one piece with a structure. In one preferred aspect of the invention, a projection and the structure, from which said projection extends, is made from the same material. In another preferred aspect of the invention, a projection and the structure, from which said projection extends, are made from different materials.

A projection may have any geometric shape. Examples of preferred shapes include a cone, a triangle, a rectangle, a cylinder, a cube, a half-sphere, a projection formed as a plane, a combination of at least two thereof. In a preferred aspect of the invention, a projection is formed as a half-sphere. In another preferred aspect of the invention, a projection is not planar. In another preferred aspect of the invention, a projection does not comprise an edge, a corner, or both.

In a preferred aspect of the invention, a projection has a height that is larger than a maximum perpendicular dimension of the projection. The maximum perpendicular dimension is measured perpendicular to a height of the projection. The maximum perpendicular dimension can be, e.g., a diameter (such as when the projection is in the form of a half-sphere or a cylinder), or a width (e.g., when the projection is in the form of a cube).

In a preferred aspect of the invention, a projection comprises at least one surface that is arranged at an angle with the first face of the first component, wherein said angle is not equal to 90°.

In a preferred embodiment of the first structure, the first structure comprises at least one recess adapted and arranged to detachably engage with at least one projection of the further structure. In this aspect, the at least one recess preferably forms part of a sidewall of a receptacle of the first structure. In this aspect, the receptacle may be any receptacle of the first structure (i.e., not necessarily a receptacle of the first plurality of receptacles).

A projection and a recess that are adapted and arranged to detachably engage should preferably be understood to mean that the projection and the recess can be engaged and disengaged multiple times, preferably without damage to the projection, the recess, or both.

In a preferred aspect of invention, a projection is arranged between at least two receptacles. In this aspect, the at least two receptacles may be any two receptacles of the first structure (i.e., not necessarily two receptacles of the first plurality of receptacles).

### Above

In one preferred embodiment of the invention, the first structure comprises at least one raised section that extends above the first face of the first component. A raised section that extends above the first face of the first component should be understood to mean that the first face is directed towards the raised section, while the further face is directed away from the raised section. A raised section that extends above the first face of the first component should preferably also be understood to mean that at least one point on the raised section is arranged at a distance from the first face of the first component. A raised section that extends above the first face of the first component should preferably also be understood to mean the following: when the first structure is placed on a horizontal surface such that the further face of the first component faces the horizontal surface, at least one point of the raised section is further from the horizontal surface compared to the first face.

In another preferred embodiment of the invention, the first structure comprises at least one projection that extends above the first face of the first component. A projection that extends above the first face of the first component should be understood to mean that the first face is directed towards the projection, while the further face is directed away from the projection. A projection that extends above the first face of the first component should preferably also be understood to mean that at least one point on the projection is arranged at a distance from the first face of the first component. A projection that extends above the first face of the first component should preferably also be understood to mean the following: when the first structure is placed on a horizontal surface such that the further face of the first component faces the horizontal surface, the at least one point of the projection is further from the horizontal surface compared to the first face.

### Containers

A container as referred herein comprises a container wall at least partially enclosing an interior volume of said container. A container as referred to herein is designed to accommodate a composition in such a way that an inner side of the container wall (i.e., the side of the container wall which faces the interior volume) and/or a coating layer (e.g., lubrication layer) on the inner side of the container wall can be in direct contact with the composition. A preferred container is suitable to be used for accommodating a pharmaceutical, medical, and/or cosmetic composition.

A first end of a container preferably comprises a first orifice, which allows for the charging of a composition into the interior volume of the container. Preferably, the first orifice also allows for the discharging of a composition from the interior volume.

A container may have any size or shape which the skilled person deems appropriate in the context of the invention. A preferred container has at least one section that is cylindrical. A preferred container is elongated.

A preferred container, more preferably the container wall, comprises, more preferably consists of, at least one glass, at least one polymer, or a combination thereof. A glass may be any type of glass and may have any composition which the skilled person deems suitable in the context of the invention. Preferably, the glass is suitable for pharmaceutical and/or medical compositions. A preferred glass is of type I in accordance with the definitions of glass types in section 3.2.1 of the European Pharmacopoeia, 7^{th} edition from 2011. Examples of a preferred glass include borosilicate glass, fused silica, and combinations thereof. A particularly preferred glass is a borosilicate glass. Examples of a preferred polymer include polypropylene, polyoxymethylene, polyethylene, a cyclic olefin copolymer (COC) and a cyclic olefin polymer (COP). Here a cyclic olefin copolymer (COC) and a cyclic olefin polymer (COP) are particularly preferred.

Examples of preferred containers include cartridges, vials, ampules, carpules, and syringes.

In one preferred aspect of the invention, a container, more preferably a container wall, even more preferably a surface of the container wall facing the interior volume of the container, does not comprise a coating. In another preferred aspect of the invention, a container, more preferably the container wall, even more preferably a surface of the container wall facing the interior volume of the container, comprises at least one coating layer. Here a coating layer should preferably be understood as a layer that is applied by any method known to a skilled person working in the pharmaceutical industry. A preferred coating layer is obtained by a plasma coating method. Examples of plasma coating methods include plasma impulse chemical vapour deposition and plasma-enhanced chemical vapour deposition. Preferred coating layers comprise silane or silicone.

### Pharmaceutical, Medical and Cosmetic Composition

In the context of the invention, every pharmaceutical composition, every medical composition, and every cosmetic composition which the skilled person deems suitable comes into consideration. A pharmaceutical composition is a composition comprising at least one pharmaceutically active ingredient. A preferred pharmaceutically active ingredient is a vaccine. A cosmetic composition is a composition comprising at least one cosmetically active ingredient. A preferred cosmetically active ingredient is hyaluronic acid or botulinum toxin. The pharmaceutical and/or cosmetic composition may be fluid or solid or both, wherein a fluid composition is particularly preferred herein. A preferred solid composition is granular such as a powder, a multitude of tablets or a multitude of capsules. A further preferred pharmaceutical, medical and/or cosmetic composition is a parenterialium, i.e., a composition which is intended to be administered via the parenteral route, which may be any route which is not enteral. Parenteral administration can be performed injection, e.g. using a needle (usually a hypodermic needle) and a syringe, or by the insertion of an indwelling catheter.

### BRIEF DESCRIPTION OF THE DRAWINGS

The figures serve to exemplify the present invention and should not be viewed as limiting the invention. The figures are not drawn to scale. Wording such as “uppermost”, “lowermost”, “upper”, “lower”, “above”, “below”, or similar should be understood with reference to, and in the context of, the figures.

FIG. 1A: schematic illustration of a cross-section of a first structure according to the invention, viewed from the side.

FIG. 1B: schematic illustration of a cross-section of a first structure, according to the invention, arranged in contact with a further structure.

FIGS. 1C, 1D and 1E: alternative embodiments of the first structure shown in FIG. 1A.

FIG. 2A: schematic illustration of a first embodiment of a first structure according to the invention, shown in an isometric view.

FIG. 2B: schematic illustration of a cross-section of the first embodiment of the first structure.

FIG. 3A: schematic illustration of a second embodiment of a first structure according to the invention, shown in an isometric view.

FIG. 3B: schematic illustration of a cross-section of the second embodiment of the first structure.

FIG. 4A: schematic illustration of a third embodiment of a first structure according to the invention, viewed from above.

FIG. 4B: schematic illustration of a cross-section of the third embodiment of the first structure.

FIG. 5A: schematic illustration of a fourth embodiment of a first structure according to the invention, showing a cut-out of the first structure.

FIG. 5B: schematic illustration showing a cross-sectional cut of FIG. 5A.

FIGS. 6A, 6B, 6C and 6D: schematic illustrations showing the arrangement of the first plurality of receptacles in the first structure.

FIGS. 7A and 7B: schematic illustrations showing how various parameters are defined.

FIGS. 8A and 8B: schematic illustration showing how various parameters of a protrusions are defined.

FIG. 9: schematic illustration showing how dimensions of a projection is measured.

FIG. 10: flow diagram showing the steps of a method for processing at least two structures

### DETAILED DESCRIPTION

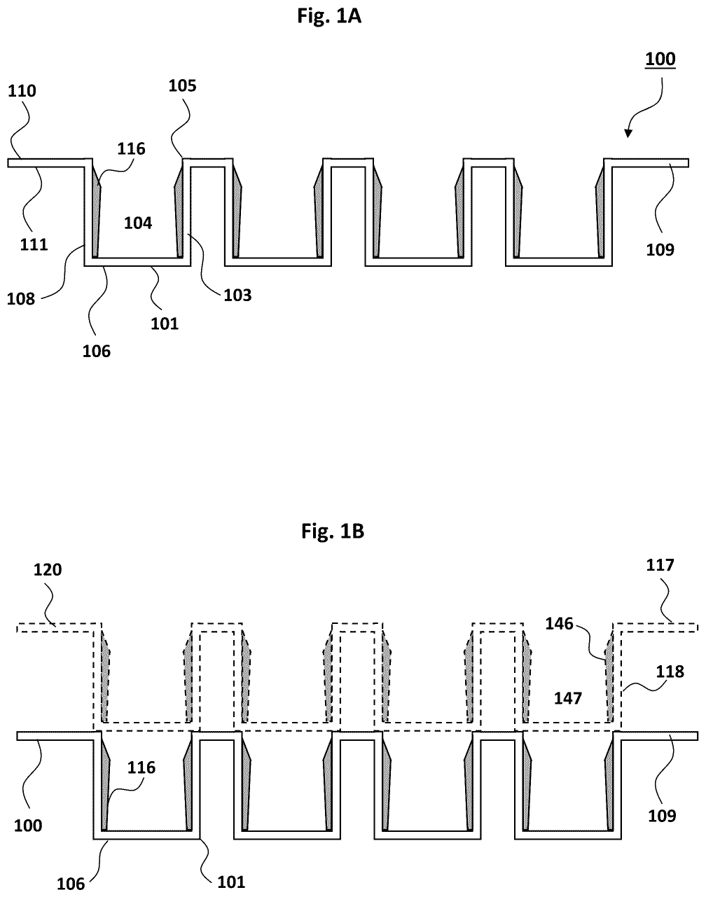

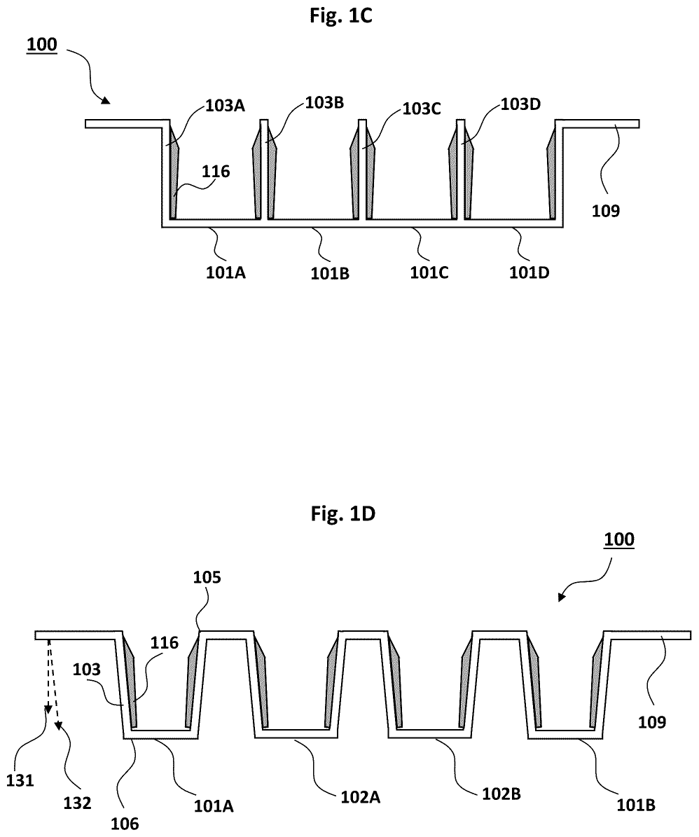

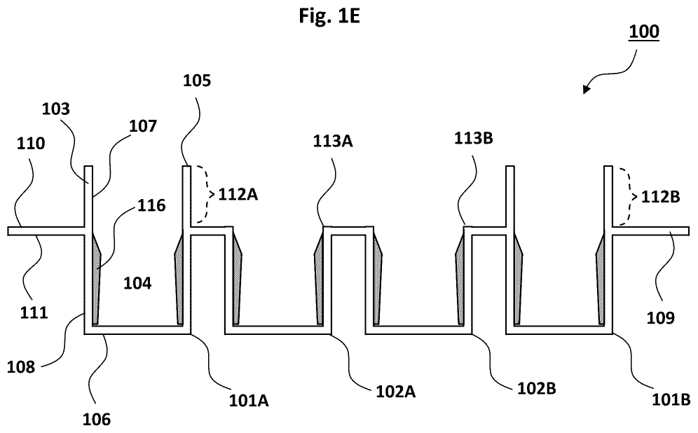

### FIG. 1A

FIG. 1A shows a schematic illustration of a cross-section of a first structure 100 according to the invention, viewed from the side. The first structure 100 has a first plurality of receptacles, such as receptacle 101. As shown for receptacle 101, each receptacle of the first structure 100 has a sidewall 103 enclosing an interior 104. Each receptacle also has a first end 105 and a further end 106. A container is inserted into and removed from the first structure 100 via the first end 105. Although FIG. 1A shows that the further end 106 is closed, this is not a requirement. I.e., the further end 106 may also be open. A sidewall of a receptacle has an outer surface 108 and an inner surface (now shown in FIG. 1A), opposite the outer surface, that faces the interior 104 of the receptacle 101.

As shown for receptacle 101, each receptacle (of the first plurality of receptacles) has protrusions, such as protrusion 116, that extend into the interior 104 of the receptacle. These protrusions are for the positioning of containers in the receptacles and are formed as one piece with the sidewalls from which said protrusions extend. The first structure 100 further comprises a first component 109 that surrounds the first plurality of receptacles. The first component 109 has an upper face 110 and a lower face 111. The upper face 109 faces the first ends of the receptacles (e.g., 105), while facing away from the further ends (e.g., 106) of the receptacles.

### FIG. 1B

FIG. 1B shows a schematic illustration of a cross-section of a first structure 100, according to the invention, arranged in contact with a further structure 117. The cross-section is viewed from the side.

The first structure 100 in FIG. 1B is the same as the first structure 100 shown in FIG. 1A. Furthermore, the further structure 117 is configured in the same manner as the first structure 100. In other words, the first structure 100 and the further structure 117 are identical. For example, the first structure 100 has a first plurality of receptacles (such as receptacle 101) and the further structure 117 has a further plurality of receptacles (such as receptacle 118). The first and further pluralities of receptacles are identical. Both the first structure 100 and the further structure 117 have protrusions (such as protrusions 116 and 146, respectively) that extend into the interiors of the receptacles of said structures (such as interiors 104 and 147, respectively). Furthermore, similar to the first component 109 of the first structure 100, the further structure 117 has a further component 120 that surrounds the receptacles of the further structure 117. The first component 109 and the further component 120 are also identical.

As shown in FIG. 1B, the further structure 117 is arranged in contact with the first structure 100. More specifically, the further structure 117 is stacked on the first structure 100. The first structure and the further structure 117 are adapted and arranged such that the further plurality of receptacles (of the further structure 117) are not in contact with the protrusions (such as protrusion 116) of the first plurality of receptacles (of the first structure 100).

Although the first structure 100 and the further structure 117 in FIG. 1B are identical, this is not a requirement. For example, any first structure that allows for a stacking of the first structure and a further structure such that 30% or less of the receptacles, forming part of the first plurality of receptacles, are in contact with the protrusions of the further plurality of receptacles is according to the invention.

### FIGS. 1C to 1E

FIGS. 1C to 1E show alternative embodiments of the first structure 100 shown in FIG. 1A. As shown in FIG. 1C, the receptacles of the first structure 100 can share sidewalls. For example, the receptacles 101A and 101B share the sidewall 103B, the receptacles 101B and 101C share the sidewall 103C, and the receptacles 101C and 101D share the sidewall 103D.

FIG. 1D shows that the receptacles may have a varying diameter. Using receptacle 101A as an example, it can be seen that a diameter of said receptacle decreases from the first end 105 to the further end 106 of said receptacle. FIG. 1D also shows how an angle α between a normal 131 of the first component 109 and the sidewall 103 of receptacle 101A is defined. The angle α is defined between the normal 131 and the line 132, wherein said line 132 is parallel to the sidewall 103.

FIG. 1E shows a first structure 100 where the first plurality of receptacles have raised sections. The first structure 100 in FIG. 1E also has a second plurality of receptacles, such as receptacles 102A and 102B (the difference between the first and second plurality of receptacles will be described below). As shown for the receptacles 101A and 101B, each receptacle of the first plurality of receptacles has at least one raised section (112A and 112B, respectively) that extends above the upper face 110 of the first component 109. The raised sections 112A and 112B form part of the sidewalls of the receptacles 101A and 101B, respectively, as well as forming part of the first ends of said receptacles. In other words, as shown for receptacle 101A, the first end 105 of the receptacle 101A is above the upper face 110. This is in contrast to the receptacles 102A and 102B, which have first ends 113A and 113B that are flush with the upper face 110 of the first component 103. In other words, receptacles 101A and 101B (of the first plurality of receptacles) are distinguished from receptacles 102A and 102B (of the second plurality of receptacles) by the presence of a raised section (e.g., 112A and 112B).

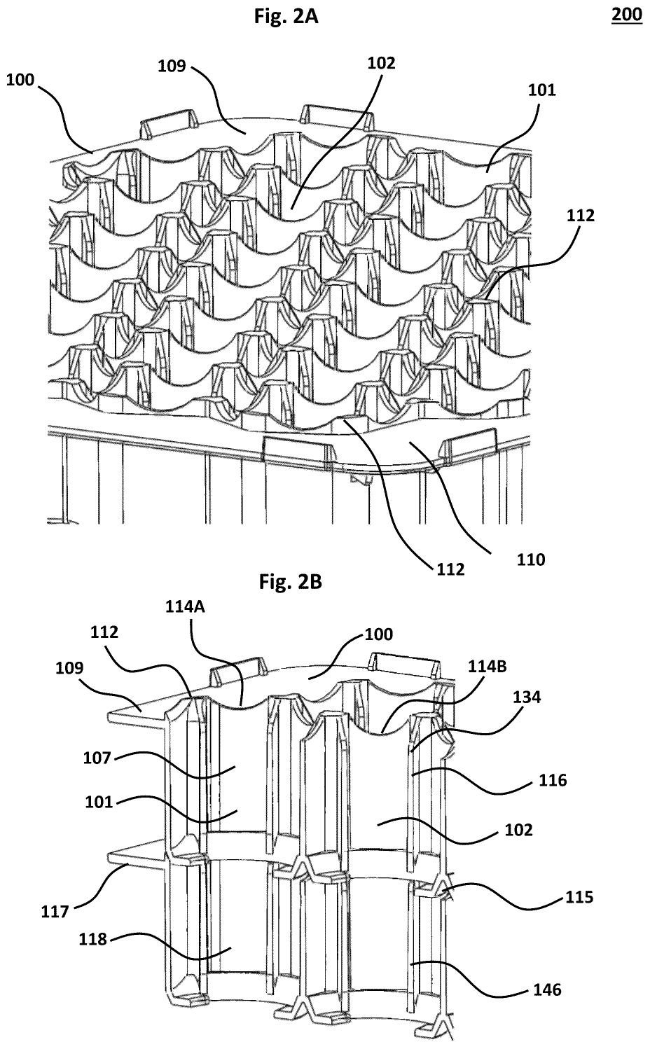

### FIGS. 2A and 2B

FIG. 2A is a schematic illustration of a first embodiment 200 of a first structure 100 according to the invention, shown in an isometric view. The first structure 100 has a first plurality of receptacles, such as receptacle 101, and a second plurality of receptacles, such as receptacle 102. The first structure also has a first component 109 that surrounds the receptacles of the first structure. The first plurality and the further plurality of receptacles have raised sections 112 that extend above the first face 110 of the first component 109.

FIG. 2B is a schematic illustration of a cross-section of the first embodiment of the first structure 100 shown in FIG. 2A. FIG. 2B shows that the first ends of the first plurality of receptacles, as well as the first ends of the second plurality of receptacles, have recesses. For example, receptacle 101, of the first plurality of receptacles, has a recess 114A, while receptacle 102, of the second plurality of receptacles, has a recess 114B. Furthermore, the recess 114B is deeper than the recess 114A. FIG. 2B also shows that the further ends of the first plurality of receptacles, as well as the further ends of the second plurality of receptacles, have recesses. As an example, the receptacle 102 has a recess 115 in a further end of said receptacle. Both the first and second plurality of receptacles also have protrusions, such as protrusion 116, extending into the interior of the receptacles. These protrusions are adapted and arranged for positioning containers in the receptacles when said containers are inserted, held, and removed from the receptacles. The protrusions also have vertices, such as vertex 134.

FIG. 2B further shows that the first structure 100 is stacked onto a further structure 117. The further structure 117 has the same configuration as the first structure 100 (e.g., comprises a first and further plurality of receptacles with recesses in the first and further ends, as well as receptacles with raised sections). The receptacles of the further structure 117 also have protrusions 146 extending into the interiors of said receptacles. The raised sections of the further structure 117 are adapted and arranged to be received in the recesses at the further ends of the receptacles of the first structure 100. Furthermore, the receptacles of the first structure 100 are not located in the receptacles of the further structure 117, such as receptacle 118. As a result, the receptacles of the first structure 100 are not in contact with the protrusions of the further structure 117.

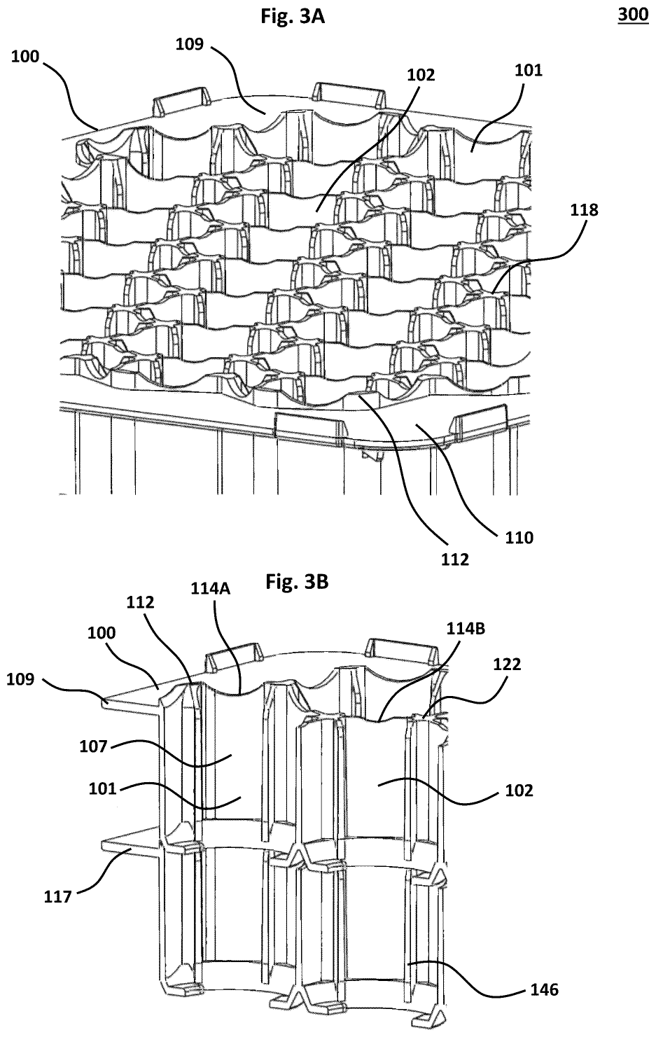

### FIGS. 3A and 3B

FIGS. 3A and 3B are schematic illustrations of a second embodiment 300 of a first structure 100 according to the invention, shown in an isometric view. The first structure 100 of FIGS. 3A and 3B are the same as the first structure 100 of FIGS. 2A and 2B, with the following difference. The first ends of the second plurality of receptacles of the first structure 100, as shown in FIG. 3A, does not have a raised section that extends above the first component 109. Rather, sections of the first ends (such as section 122) of the second plurality of receptacles are level with the first component 109, while other sections (such as the recess 114B) are below the first component 109. This is further illustrated in FIG. 3B, where it can be seen that section 122 is at a lower height compared to the raised section 112. In FIG. 3B it can also be seen that only the first plurality of receptacles have raised sections, and that the first plurality of receptacles are arranged as the outermost receptacles. Furthermore, only the sections of the sidewalls of the receptacles, of the first plurality of receptacles, that are directly adjacent to the first component 109 extend above the first component 109. Recesses, such as 114A, between raised sections are also deeper than recesses, such as 114B, which are not located between two raised sections.

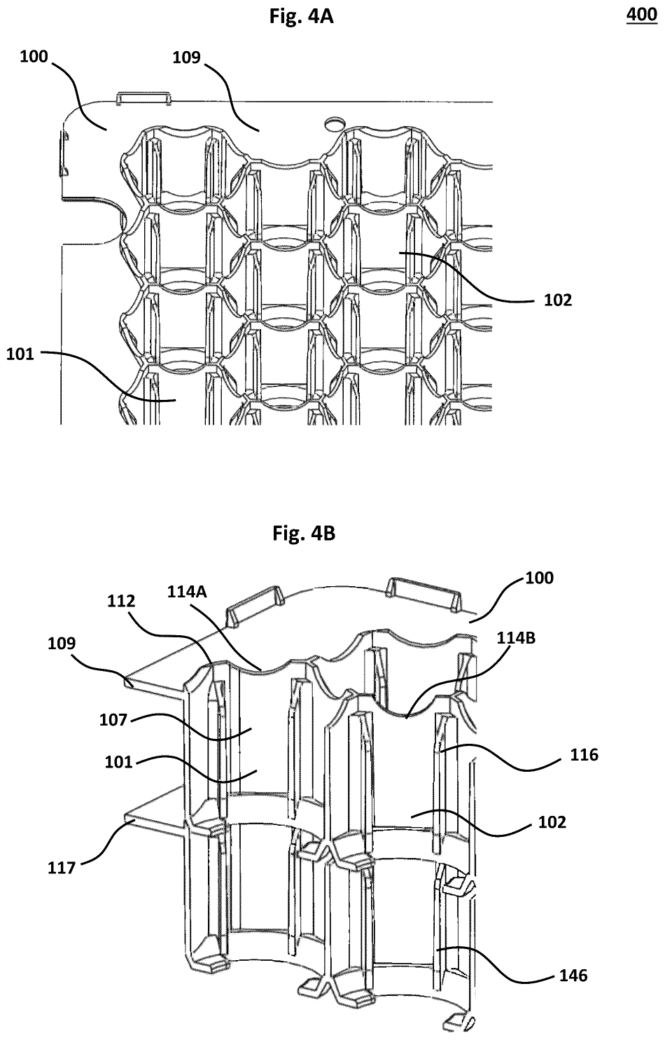

### FIGS. 4A and 4B

FIGS. 4A and 4B are schematic illustrations of a third embodiment 400 of a first structure 100 according to the invention. The third embodiment 400 of the first structure 100 of FIGS. 4A and 4B are the same as the first structure shown in FIGS. 2A and 2B, with the following difference. The protrusions of the first structure 100 of FIG. 2 extend along the entire maximum lengths of the receptacles. This is in contrast to the protrusions of the first structure of FIGS. 4A and 4B. As can be seen in FIG. 4B, the protrusions, such as protrusions 116 and 146, does not extend along the entire maximum length of the receptacles. This holds for both the first plurality of receptacles and the second plurality of receptacles.

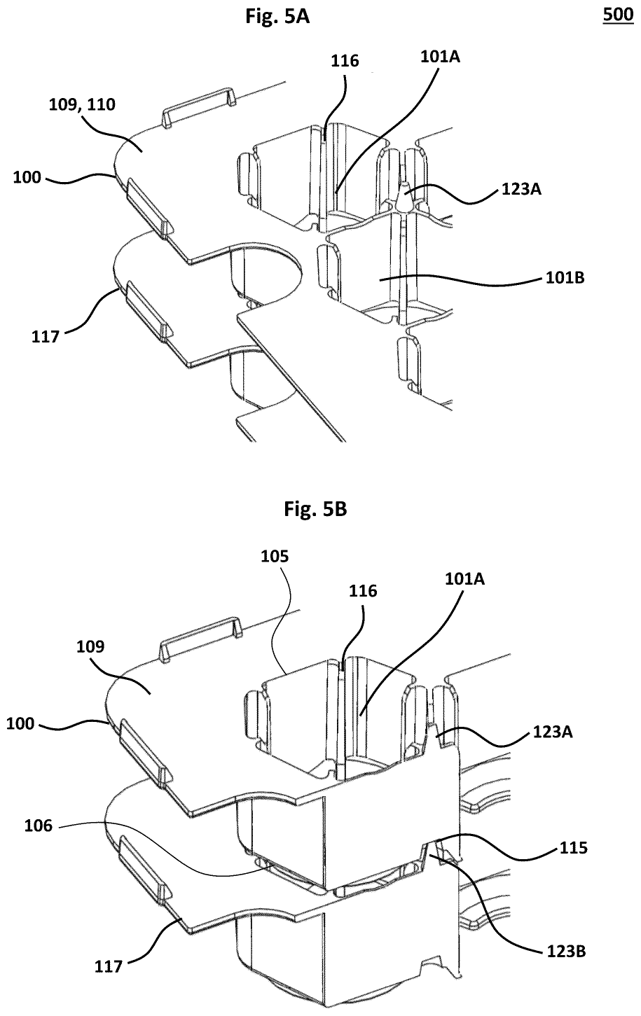

### FIGS. 5A and 5B

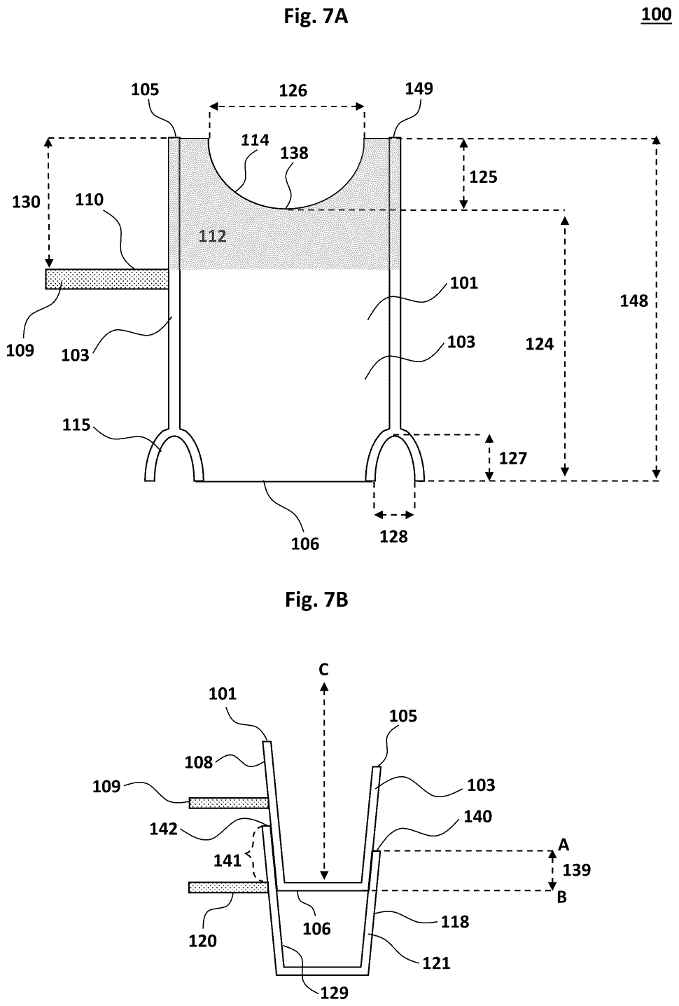

FIGS. 5A and 5B are schematic illustrations of a fourth embodiment 500 of a first structure 100 according to the invention. FIG. 5A is schematic illustration showing a cut-out of the first structure 100 stacked onto a further structure 117. FIG. 5B shows a cross-sectional cut of FIG. 5A. FIG. 5A shows that the first structure 100 has projections, such as projection 123A, that extend above the first face 110 of the first component 109. These projections may be arranged between the first plurality of receptacles, such as receptacles 101A and 101B in FIG. 5A. As shown in the FIG. 5B, a receptacle (of the first plurality of receptacles) may comprise a recess 115 at a further end 106 of said receptacle, wherein said recess 115 is adapted and arranged to receive a projection of the further structure 117 (such as projection 123B). Amongst other advantages, the projections allow for restricting a movement of the first structure 100 relative to the further structure 117. Here the movement includes both a translational and a rotational movement. The projections may also allow for restricting an insertion length (see FIG. 7B and the accompanying figure description).

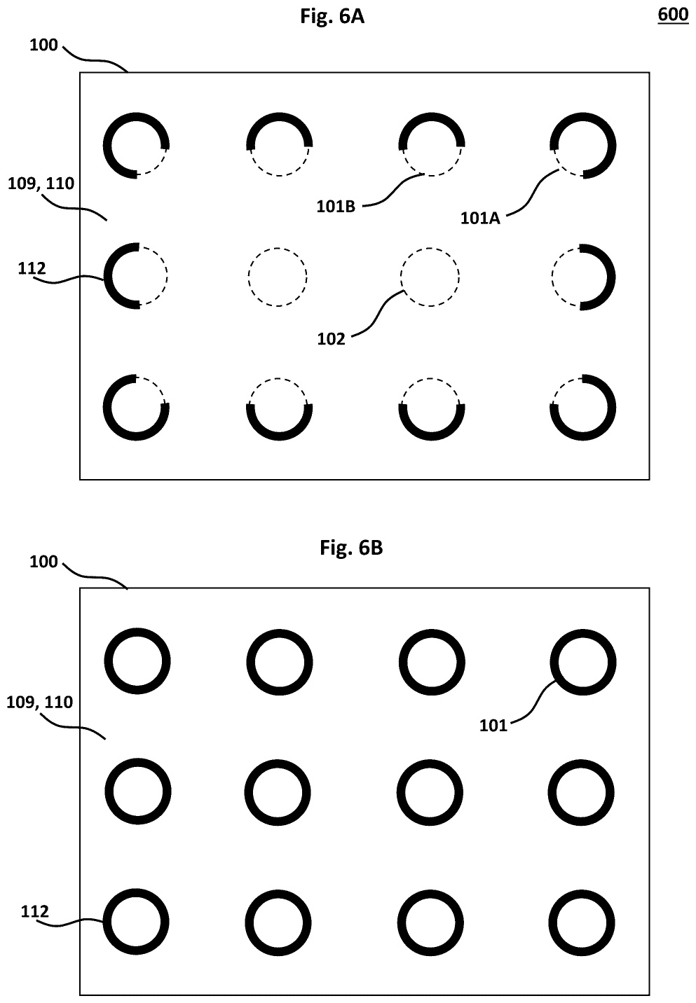

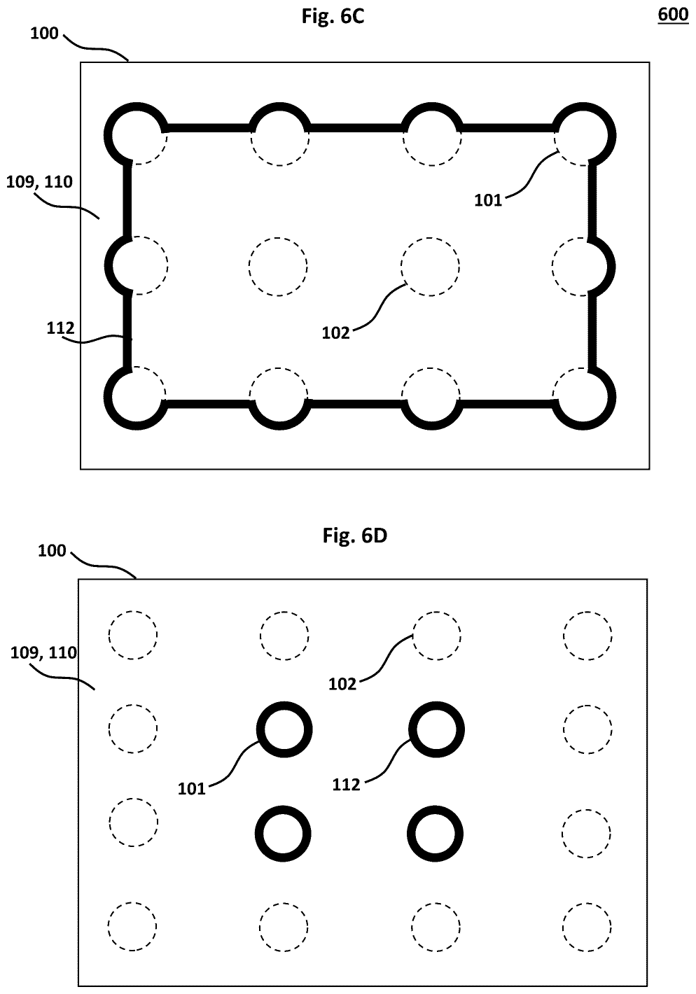

### FIGS. 6A to 6D

FIGS. 6A to 6D shows variation embodiments of the arrangement of the first plurality of receptacles in the first structure 100. FIG. 6A shows a first structure 100 viewed from above. The first structure comprises a first plurality of receptacles (such as receptacles 101A and 101B), wherein each receptacle, of the first plurality of receptacles, has a raised section (such as raised section 112). The raised sections are indicated by the thicker lines. The first structure 100 also has a second plurality of receptacles (such as receptacle 102). The second plurality of receptacles are characterised by the absence of a raised section. As can be seen in FIG. 6A, the raised sections do not extend around the entire circumference of the first plurality of receptacles. For example, the raised section of receptacle 101A extends around 75% of the circumference of said receptacle. By contrast, the raised section of receptacle 101B extends around 50% of the circumference of said receptacle. Furthermore, FIG. 6A shows that the first plurality of receptacles are arranged in the first structure such that said receptacles form the outermost receptacles of the first structure.

FIG. 6B shows an alternative of the first structure 100 of FIG. 6A. As can be seen in FIG. 6B, the first structure 100 has only a first plurality of receptacles. Furthermore, the raised sections 112 of said receptacles extend around the entire circumference of said receptacles.

FIG. 6C shows an alternative of the first structure 100 of FIG. 6A. As can be seen in FIG. 6C, the raised sections 112 do not only form part of the sidewalls of the first plurality of receptacles, but the raised section 112 may also extend between the first plurality of receptacles.

FIG. 6D shows an alternative of the first structure 100 of FIG. 6A. As can be seen in FIG. 6D, the first plurality of receptacles may be arranged in the centre of the first structure.

It should be noted that FIGS. 6A to 6D are only examples of embodiments of the first structure and should not be seen as limiting. For example, the first structure may have only a first plurality of receptacles with raised sections that extend around only 50% of the circumference of said receptacles.

### FIGS. 7A and 7B

FIGS. 7A and 7B are schematic illustration showing how various parameters are defined. FIG. 7A shows a cross-sectional cut of a receptacle 101 (forming part of the first plurality of receptacles). As shown in FIG. 7A, a minimum length 124 of the receptacle 101 is defined between a lowermost point 138 of the first end 105 and the lowermost point of the further end 106 of the receptacle 101. It should be noted that the lowermost point 138 of the first end 105 does not necessarily have to be located in a recess, such as recess 114. For example, a receptacle may have a raised section with a non-uniform height and no recess, wherein said raised section extends around 100% of the circumference of the receptacle. Here the lowermost point 138 will be measured at a position where the height of the raised section is the smallest. As another example, a receptacle may have a raised section that only extends around 50% of a circumference of the receptacle (see, e.g., receptacle 101B in FIG. 6A). In this case, the lowermost point 138 will not be located on the raised section but will be located at a position on the first end 105 where there is no raised section. In contrast to the minimum length 124, a maximum length 148 of a receptacle 101 is defined between an uppermost point 149 of the first end 105 and the lowermost point of the further end 106 of the receptacle 101. If a receptacle has a non-uniform diameter (e.g., the receptacle has a conical form), the minimum and maximum lengths are measured parallel to a line that passes through a centre of the receptacle, as shown for the receptacles in FIG. 7B. In some embodiments the minimum length and the maximum length of a receptacle may be equal. For example, a receptacle has a raised section that extends around 100% of the circumference of said receptacle, wherein the raised section has a uniform height and no recess. Another example is a receptacle with a first end that is flush with the first component.

FIG. 7A also shows how a depth 125 and a width 126 of a recess 114 in the first end 105 of the receptacle 101 is measured. FIG. 7A further shows how a depth 127 and a width 128 of a recess 115 in a further end 106 of the receptacle 101 is measured. It can also be seen in FIG. 7A that any section of the sidewall 103 that is above the first face 110 of the first component is defined as a raised section 112, with said raised section 112 indicated by the grey shading. A height 130 of the raised section 112 is measured as indicated, i.e., said height 130 is measured from the first face 110 to the uppermost point of the raised section 112. The height 130 is measured perpendicular to the first face 110.

FIG. 7B illustrates how a length of a sidewall of a first receptacle 101, located in a further receptacle 118, is determined (the first receptacles 101 forms part of a first plurality of receptacles and the further receptacle 118 forms part of a further plurality of receptacles). As can be seen in FIG. 7B for receptacle 101, a section of the sidewall 103 between points A is B is located in the receptacle 118, with points A and B separated by a distance 139. This distance 139 is also referred to an insertion length. As also shown in FIG. 7B, the receptacle 118 has a further component 120 and a raised section 141. Furthermore, the sidewall 121 of the receptacle 118 has a varying height (i.e., the raised section 141 does not extend with a uniform height around the receptacle 118). Comparable to how a minimum length of a receptacle is measured, the insertion length 139 is measured with respect to the lowermost point 140 of the first end (of the sidewall 121) of the further receptacle 118. Therefore, the insertion length is not measured with respect to an uppermost point 142 of the first end (of the sidewall 121) of the further receptacle 118. The fraction of a length of a sidewall of a first receptacle 101, located in a further receptacle 118, is calculated by dividing the insertion length 139 by the minimum length of the receptacle 101.

FIG. 7B also illustrates how a maximum length and minimum length of a receptacle with a non-uniform diameter is measured. As shown for receptacle 101, said lengths are measured parallel to a line C that passes through the centre of the receptacle 101.

FIG. 7B further shows how the percentage of an outer surface of the sidewall of a first receptacle 101, that is in contact with the inner surface of the sidewall of a further receptacle 118, is determined. In FIG. 7B, the outer surface 108 of the sidewall 103 touches the inner surface 129 of the sidewall 121 between the points A and B. This size of this contact area, as a fraction of the total surface area of the outer surface 108, determines the aforementioned percentage. When determining the total surface area of the outer surface 108, the bottom of the receptacle 101 is not included. In other words, regardless of whether the further end 106 of the receptacle 101 is open or closed, the outer surface 108 will have the same total surface area. Furthermore, as defined for the insertion length 139, the fraction of contact between the respective surfaces of the receptacles 101 and 118 are measured with respect to the lowermost point 140 of the first end (of the sidewall 121) of the further receptacle 118.

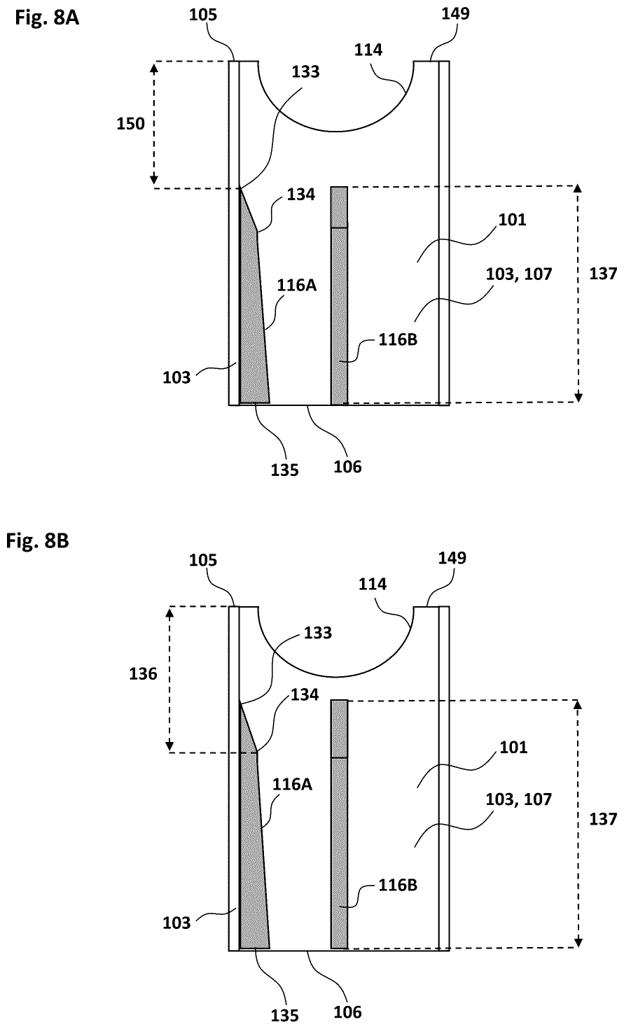

### FIGS. 8A and 8B

FIG. 8A shows a cross-sectional cut of a receptacle 101 (forming part of the first plurality of receptacles). The receptacle has protrusions 116A and 116B extending into the interior of the receptacle 101 (protrusion 116A is viewed from the side while protrusion 116B is viewed from the front). Said protrusions do not have a uniform thickness. Rather, as can be seen for protrusion 116A, the thickness increases from a first end 133 to a point 134 to form a surface that may be used to facilitate an insertion of a container into the receptacle. The thickness of the protrusion 116A further increases between the point 134 to a further end 135 of the protrusion 116A. However, the rate of increase of the thickness between first end 133 and point 134 is larger than the rate of increase of the thickness between the point 134 and further end 135. The point 134 therefore forms a vertex, which in turn is part of an edge of the protrusion 116A. In an alternative embodiment, a thickness of the protrusion 116A may also decrease between the point 134 and the further end 135.

FIG. 8A also shows how a first distance 150 between the first end 105 of the receptacle and the first end 133 of a protrusion 116A is measured. Said first distance 150 is measured from the uppermost point 149 (in the sense of FIG. 8A) of the first end 105. FIG. 8A further shows how a length 137 of a protrusion is measured. If the sidewall of a receptacle has a varying diameter, as shown in, e.g., FIG. 7A, the first distance 150 and the length 137 are measured parallel to a line that passes through the centre of the receptacle (see line C in FIG. 7B).

FIG. 8B shows how a second distance 136 between the first end 105 of the receptacle and the vertex 134 is measured. Said second distance 136 is measured from the uppermost point 149 (in the sense of FIG. 8B) of the first end 105. If the sidewall of a receptacle has a varying diameter, as shown in, e.g., FIG. 7A, the second distance 136 is measured parallel to a line that passes through the centre of the receptacle (see line C in FIG. 7B).

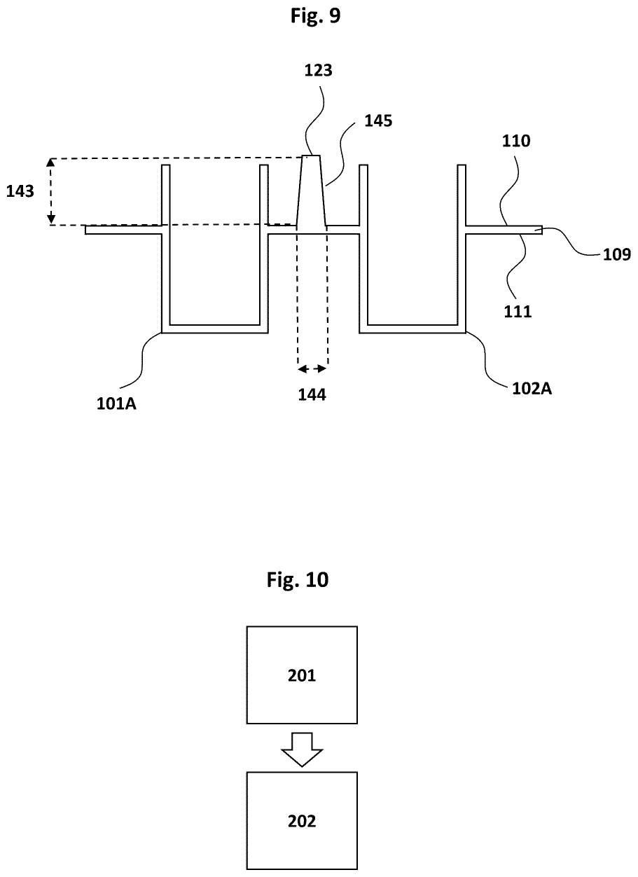

### FIG. 9

FIG. 9 is a schematic illustration showing how the dimensions of a projection are measured. FIG. 9 shows a cross-sectional cut of a simplified structure. A height 143 of a projection 123 is measured from the first face 110 of the first component 109 to an uppermost point of the projection 123. The height 143 is also measured perpendicular to the first face 110. A maximum perpendicular dimension 144 of the projection is measured perpendicular to the height 143. As shown in FIG. 9, the projection 123 is narrower at the top compared to the base. The maximum perpendicular dimension 144 is thus measured at the base of the projection 123. FIG. 9 further shows that the projection 123 has a surface 145 that is arranged at an angle with the first face 110 (i.e., said angle is not) 90°. This surface 145 allows for an easier insertion of the projection 123 into a recess of a further structure when said further structure is stacked onto the structure of FIG. 9.

### FIG. 10

FIG. 10 is a flow diagram showing the steps of a method for processing at least two structures. In step 201 a first structure, as shown in FIG. 1A, is provided. The first structure has a first plurality of receptacles that comprise protrusions that extend into interiors of said receptacles. Also provided is a further structure that is configured in the same manner as the first structure. The further structure has a further plurality of receptacles with protrusions that extend into interiors of said receptacles. In step 202, the first structure is arranged in contact with the further structure by stacking the further structure on the first structure (see FIG. 1B). Furthermore, less than 10% of the receptacles, of the further plurality of receptacles, are in contact with the protrusions of the first plurality of receptacles.

### EXAMPLES

The invention is illustrated further by way of examples. The invention is not restricted to the examples.

### Example 1

Example 1 is a comparison between a structure according to the invention and a structure not according to the invention.

### Example 1.1 (Inventive)

Example 1.1 pertains to a first nest according to the invention. Such a nest is shown in, e.g., FIGS. 2A and 2B, 3A and 3B. The first nest is an example of a first structure. The first nest comprises a first plurality of receptacles that are adapted and arranged for accommodating containers. Each of the receptacles have protrusions that extend into the interiors of the receptacles.

The first nest is adapted and arranged such that when the first nest is stacked onto a further nest (also according to the invention and configured in the same manner as the first nest), less than 30% of the first plurality of receptacles are in contact with protrusions of a further plurality of receptacles (of the further nest). Similarly, when the further nest is stacked onto the first nest, less than 30% of the further plurality of receptacles (of the further nest) are in contact with the protrusions of the first plurality of receptacles.

### Example 1.2 (Comparative)

Example 1.2 pertains to a third nest not according to the invention. The third nest is thus an example of a structure that is not according to the invention. The third nest comprises a third plurality of receptacles that are adapted and arranged for accommodating containers. Each of the receptacles have protrusions that extend into the interiors of the receptacles.

The third nest is adapted and arranged such that when the third nest is stacked onto a fourth nest (configured in the same manner as the third nest) at least 50% of the third plurality of receptacles are in contact with protrusions of a fourth plurality of receptacles (of the fourth nest). Similarly, when the fourth nest is stacked onto the third nest, at least 50% of the fourth plurality of receptacles (of the fourth nest) are in contact with the protrusions of the third plurality of receptacles.

Table 1 below provide a comparison of the technical effects of the nests of Example 1.1 with the nests of Example 1.2

TABLE 1

| Example | 1.1 | 1.2 |
|---|---|---|
| Receptacles of upper nest in contact with | <30% | ≥50% |
| protrusions of receptacles of lower nest | | |
| Technical effect | | |
| Particle formation on nests | −−− | +++ |
| Force required to stack nests | −− | ++ |
| Damage during stacking of nests | −−− | ++ |
| Force required to separate nests | −− | +++ |
| Damage during separation of nests | − | + |
| Consistency of contact surfaces between | ++++ | − |
| stacked nests | | |
| Manufacturing tolerance of nests | ++ | − |
| Producing nests with desired specifications | ++ | − |
| Functioning of positioning elements | ++ | − |
| Number of nests that can be stacked | ++ | + |
| Heat transfer during lyophilization | ++ | + |

The technical effects in Table 1 are the following:
Particle formation on nests: contact between nests lead to the formation of particles on the nests. This can happen during, e.g., the stacking of the nests, the separation of the nests, and while the nests are stacked. The inner and outer surfaces of containers subsequently accommodated in the nests are contaminated by these particles. A “−” indicates less particle formation and a “+” indicated a larger particle formation. It is desired to reduce the particle formation.
Force required to stack nests: the force required to stack the nests onto each other. For example, a larger insertion length generally requires that the receptacles of the upper nest be jammed into the receptacles of the lower nest during stacking of the nests. A “−” indicates that less force is required, and a “+” indicates that more force is required. It is desired to reduce the force required.
Damage during stacking of nests: the damage that occurs during the stacking of the nests. Examples of damages include cracking and deformation of the nests. A “−” indicates that the nests are damaged less and a “+” indicates that the nests are damaged more. It is desired to reduce the damage during stacking of the nests.
Force required to separate nests: the force required to remove nests that are stacked onto each other. For example, a larger force is required when the receptacles of the upper nest are jammed, or clamped, into the receptacles of the lower nest. A “−” indicates that less force is required, and a “+” indicates that more force is required. It is desired to reduce the force required.
Damage during separation of nests: the damage that occurs during the separation of stacked nests. Examples of damages include cracking and deformation of the nests. A “−” indicates that the nests are damaged less during separation and a “+” indicates that the nests are damaged more. It is desired to reduce the damage during separation of the nests.
Consistency of contact surfaces between stacked nests: whether the contact surfaces between stacked nests remain consistent. Nests are designed to contact each other at specific points when stacked. However, when a nest is adapted and arranged such that more than 30% of a length of the sidewalls of the receptacles of said nest will be located in the receptacles of another nest when stacked, the surfaces where said nests will contact each other are difficult to control in practice. This is, amongst others, due to variations in the dimensions of the receptacles of a nest, as well as warping or bending of a nest that occurs during production and/or handling of a nest. For example, prior art nests are often designed such that the receptacles of an upper nest should equally contact the protrusions of the lower nest when stacked. However, in practice the upper nest generally tilts or moves, which leads to the upper nest contacting less protrusions of the lower nest than intended. This leads to the upper and lower nests exerting a force onto each other over a surface area that is smaller than designed. Nests that contact each other at the same, predictable surfaces when stacked are referred to as having consistent contact surfaces. A “−” indicates less consistent contact surfaces and a “+” indicates more consistent contact surfaces. It is desired to have more consistent contact surfaces.
Manufacturing tolerance of nests: the tolerance with respect to the dimensions of the nests. A “−” indicates a lower tolerance and a “+” indicates a larger tolerance. It is desired to have a larger tolerance.
Producing nests with desired specifications: how easy it is to produce nests with desired specifications. When nests are adapted and arranged such that the receptacles of stacked nests have a very limited insertion, said receptacles are primarily dimensions for receiving containers, in contrast to being dimension for receiving both containers and receptacles of another nest. As a result, the receptacles can be dimensioned to provide an improved fit for the containers when accommodated in the nest. This also allows producing nest that have less mass deviation and form deviation from the desired values. A “−” indicates that it is more difficult to produce nests with the desired specifications and a “+” indicates that it is easier. It is desired that producing nests with the desired specifications is easier.
Functioning of positioning elements: how well the positioning elements (the protrusions) of a receptacle can position a container during insertion into, removal from, and accommodation in the receptacle. If, during stacking of the nests, the receptacles of an upper nest (upper receptacles) are located in the receptacles of a lower nest (receiving receptacles), it is generally required that the positioning elements should be adapted and arranged to not only facilitate the positioning of the containers but should also be adapted and arranged to allow for the insertion of the upper receptacles into the receiving receptacles. As a result, the positioning elements generally do not function optimally. A “−” indicates that the positioning elements function less optimally and a “+” indicates that the positioning elements function more optimally. It is desired that the positioning elements function more optimally.
Number of nests that can be stacked: the number of nests that can be stacked onto each other, without damaging the nests. A “−” indicates that less nests can be stacked and a “+” indicates that more nests can be stacked. It is desired to increase the number of nests that can be stacked.
Heat transfer during lyophilization: when containers are accommodated in a nest, said containers are often subjected to a process of lyophilisation. A “−” indicates less heat transfer between the nest and the containers accommodated therein, and a “+” indicates more heat transfer. It is desired to have a more heat transfer.

### Example 2

In Example 2 nests A with varying insertion lengths are provided, as shown in Table 2. The receptacles A of a respective nest A are configured in the same manner. An insertion length of a respective nest A is defined as the length of the sidewalls of the receptacles A located in the receptacles B of a respective nest B when the respective nest A is stacked onto the respective nest B (respective nests A and B are configured in the same manner). The technical effects of the variation in insertion length are also shown in Table 2.

TABLE 2

| Example | 2.1 | 2.2 | 2.3 | 2.4 |
|---|---|---|---|---|
| Insertion length [mm] | 0 | 1 | 5 | 10 |
| Technical effect | | | | |
| Particle formation on nests | −−− | + | ++ | +++ |
| Force required to stack nests | −−− | −− | − | + |
| Damage during stacking of nests | −−− | −− | − | + |
| Force required to separate nests | −−− | −− | − | + |
| Damage during separation of nests | −− | −− | − | + |
| Consistency of contact surfaces | +++ | +++ | ++ | −−− |
| between stacked nests | | | | |
| Number of nests that can be stacked | +++ | ++ | + | −−− |

The technical effects in Table 2 are the same as described for Table 1.

### Example 3

In Example 3 nests are provided as shown in FIGS. 2A and 2B. The exception is Example 3.1, where the nest has no raised sections. The height of the raised sections is varied between the nests, as shown in Table 3 below. The technical effects of the variation in height are also shown in Table 3.

TABLE 3

| Example | 3.1 | 3.2 | 3.3 | 3.4 | 3.5 |
|---|---|---|---|---|---|
| Raised sections | | | | | |
| Height [mm] | No raised | 1 | 3 | 6 | 10 |
| | sections | | | | |
| Technical effect | | | | | |
| Restriction of movement when | −−−−− | + | ++ | ++ | +++ |
| stacked | | | | | |
| Particle formation on nests | +++ | − | −− | −− | −− |
| Force required to stack nests | +++ | + | −− | −− | −−− |
| Damage during stacking of nests | +++ | + | − | −− | −− |
| Force required to separate nests | +++ | ++ | + | − | −− |
| Damage during separation of | ++ | + | − | − | −− |
| nests | | | | | |
| Distribution of force when | − | + | ++ | +++ | +++ |
| stacked | | | | | |
| Consistency of contact surfaces | −−− | +++ | +++ | +++ | +++ |
| between stacked nests | | | | | |
| Manufacturing tolerance of nests | − | + | + | + | + |
| Functioning of positioning | −−− | + | ++ | +++ | +++ |
| elements | | | | | |
| Number of nests that can be | −−− | + | ++ | ++ | ++ |
| stacked | | | | | |

The technical effects in Table 3 are the same as described for Tables 1 and 2. In addition, Table 3 has the following technical effect:
Restriction of movement when stacked: how restricted the movement of two nests relative to each other is when said nests are stacked. Examples of a movement may include one or more of the following: a rotation, a translation, a tilting. A “−” indicates less restricted movement and “+” more restricted movement (i.e., the nests can move less relative to each other). It is desired to have the relative movement restricted (less movement).
Distribution of force when stacked: when an upper nest is stacked onto a lower nest, the upper nest exerts force on the lower nest over a contact area. A larger contact area leads to an improved distribution of force over the lower nest. A “−” indicates less force distribution and a “+” indicates more force distribution. It is desired to have an improved distribution of force.

### Example 4

In Example 4 nest are provided with varying iterations of the following features: raised sections and projections (a nest with projections is shown in FIGS. 5A and 5B, feature 123A). The various iterations are shown in Table 4. E.g., the nest in Example 4.2 has a raised section but no projection (e.g., as shown in FIGS. 2A and 2B). The technical effects related to these features are also shown in Table 4.

TABLE 4

| Example | 4.1 | 4.2 | 4.3 | 4.4 |
|---|---|---|---|---|
| Contains feature | | | | |
| Raised section | No | Yes | No | Yes |
| Projections | No | No | Yes | Yes |
| Technical effect | | | | |
| Restriction of movement when stacked | −− | ++ | ++ | +++ |
| Particle formation on nests | +++ | −− | −−− | −− |
| Force required to stack nests | + | − | −− | − |
| Damage during stacking of nests | ++ | −− | −−− | −− |
| Force required to separate nests | + | −− | −−− | − |
| Damage during separation of nests | ++ | −− | −−− | − |
| Distribution of force when stacked | −−− | ++ | +++ | ++ |
| Consistency of contact surfaces between | −−− | ++ | +++ | ++ |
| stacked nests | | | | |
| Manufacturing tolerance of nests | −− | + | ++ | + |
| Producing nests with desired specifications | −− | + | ++ | + |
| Functioning of positioning elements | −−− | + | +++ | +++ |
| Number of nests that can be stacked | −−− | ++ | +++ | +++ |

The technical effects in Table 4 are the same as described for Tables 1 to 3.

### Example 5

In Example 5 first nests are provided (as shown in, e.g., FIGS. 2A and 2B, 3A and 3B.). The first nests are examples of a first structure. Each first nest comprises a first plurality of receptacles that are adapted and arranged for accommodating containers. Each of the receptacles have protrusions that extend into the interiors of the receptacles.

Each first nest is adapted and arranged such that when the first nest is stacked onto a further nest (also according to the invention and configured in the same manner as the first nest), less than 30% of the first plurality of receptacles are in contact with protrusions of a further plurality of receptacles (of the further nest). Similarly, when the further nest is stacked onto the first nest, less than 30% of the further plurality of receptacles (of the further nest) are in contact with the protrusions of the first plurality of receptacles.

In Example 5, some contact may be present between the protrusions of the lower nest and the receptacles of the upper nest (if the lower nest is the first structure, then the upper nest is the further structure, and vice versa), with the limitation that this contact is present for less than 30% of the receptacles of the upper nest. If a receptacle is in contact with a protrusion, a certain length of a sidewall of the receptacle (a “contact length”) is in contact with said protrusion. This contact length is varied in Example 5, as shown in Table 5 below.

TABLE 5

| Example | 5.1 | 5.2 | 5.3 | 5.4 | 5.5 |
|---|---|---|---|---|---|
| Contact length [mm] | 0 | 1 | 4 | 7 | 10 |
| Technical effect | | | | | |
| Particle formation on nests | −−− | −− | − | + | ++ |
| Force required to stack nests | −−− | −− | − | − | + |
| Damage during stacking of nests | −−− | + | + | + | + |
| Force required to separate nests | −−− | −− | −− | − | + |
| Damage during separation of nests | −−− | −− | − | − | + |
| Consistency of contact surfaces | +++ | −− | −− | −− | −−− |
| between stacked nests | | | | | |
| Number of nests that can be stacked | +++ | ++ | + | − | − |

The technical effects in Table 5 are the same as described for Tables 1 to 4.

### REFERENCE LIST

100 First structure
101, 101A, 101B, 101C, 101D Receptacles of first plurality of receptacles
102, 102A, 102B Receptacles of second plurality of receptacles
103, 103A, 103B, 103C, 103D Sidewall
104 Interior of receptacle
105 First end of receptacle
106 Further end of receptacle
107 Inner surface of sidewall
108 Outer surface of sidewall
109 First component
110 First face of first component
111 Further face of first component
112, 112A, 112B Raised section
113A, 113B First ends of second plurality of receptacles
114, 114A, 114B Recess in first end
115 Recess in further end
116, 116A, 116B Protrusion
117 Further structure
118 Receptacle of further plurality of receptacles
120 Further component
121 Sidewall
122 Section of first end of receptacle of second plurality of receptacles
123, 123A, 123B Projection
124 Minimum length of receptacle
125 Depth of recess in first end
126 Width of recess in first end
127 Depth of recess in further end
128 Width of recess in further end
129 Inner surface of sidewall
130 Height of raised section
131 Normal
132 Line parallel to sidewall
133 First end of protrusion
134 Vertex
135 Further end of protrusion
136 Second distance between first end and vertex
137 Length of protrusion
138 Lowermost point of first end
139 Insertion length
140 Lowermost point of first end of further receptacle
141 Raised section
142 Uppermost point of first end of further receptacle
143 Height of projection
144 Maximum perpendicular dimension of projection
145 Angled surface of projection
146 Protrusion
147 Interior of receptacle
148 Maximum length of a receptacle
149 Uppermost point of first end
150 First distance between first ends of receptacle and protrusion

What is claimed is:

1. A first structure comprising:
a. a first plurality of receptacles, wherein each receptacle of the first plurality of receptacles
i. is adapted and arranged for accommodating a container;
ii. has a first end and a further end opposite the first end,
iii. comprises a sidewall that at least partially encloses an interior of the receptacle;
iv. comprises at least one protrusion extending into the interior of the receptacle;
wherein
the first structure is adapted and arranged such that when the first structure is arranged in contact with a further structure comprising a further plurality of receptacles, wherein each receptacle of the further plurality of receptacles
i. is adapted and arranged for accommodating a container,
ii. has a first end and a further end opposite the first end,
iii. comprises a sidewall that at least partially encloses an interior of the receptacle,
iv. comprises at least one protrusion extending into the interior of the receptacle;
at least one of the following applies:
I. 30% or less of the receptacles, forming part of the first plurality of receptacles, are in contact with the protrusions of the further plurality of receptacles;
II. 30% or less of the receptacles, forming part of the further plurality of receptacles, are in contact with the protrusions of the first plurality of receptacles.

2. The first structure as recited in claim 1 wherein at least one of the following applies when the first structure is arranged in contact with the further structure:
a. 20% or less of a maximum length of the receptacles, of the first plurality of receptacles, are in contact with the protrusions of the further plurality of receptacles;
b. 20% or less of a maximum length of the receptacles, of the further plurality of receptacles, are in contact with the protrusions of the first plurality of receptacles.

3. The first structure as recited in claim 1 wherein at least one of the following applies when the first structure is arranged in contact with the further structure:
a. a length of the sidewall of a respective receptacles of the first plurality of receptacles in contact with at least one protrusion of the further plurality of receptacles is 10 mm or less;
b. a length of the sidewall of a respective receptacle of the further plurality of receptacles in contact with at least one protrusion of the first plurality of receptacles is 10 mm or less.

4. The first structure as recited in claim 1 wherein an average length of the protrusions of the first plurality of receptacles is less than an average maximum length of the receptacles, of the first plurality of receptacles.

5. The first structure as recited in claim 1 wherein a ratio of the average length of the protrusions of the first plurality of receptacles to the average maximum length of the receptacles of the first plurality of receptacles is in the range from 0.05 to 1.

6. The first structure as recited in claim 1 wherein the average length of the protrusions of the first plurality of receptacles is in the range from 10 to 90 mm.

7. The first structure as recited in claim 1 wherein each receptacle of the first plurality of receptacles comprises at least one protrusion extending into the interior of said receptacle, wherein
I. the at least one protrusion has a first end, and
II. a first distance between the first end of the respective receptacle and the first end of the protrusion is larger than zero, wherein the first distance is measured parallel to a maximum length of the respective receptacle.

8. The first structure as recited in claim 7 wherein a ratio of the first distance to the maximum length of the respective receptacle is in the range from 0 to 0.9.

9. The first structure as recited in claim 7 wherein the first distance is in the range from 0 to 110 mm.

10. The first structure as recited in claim 1 wherein each receptacle of the first plurality of receptacles comprises at least one protrusion extending into the interior of said receptacle, wherein
I. the at least one protrusion comprises at least one vertex, and
II. a second distance between the first end of the receptacle and the at least one vertex is larger than zero, wherein the second distance is measured parallel to a maximum length of the respective receptacle.

11. The first structure as recited in claim 10, wherein a ratio of the second distance to the maximum length of the respective receptacle is in the range from 0.005 to 0.75.

12. The first structure as recited in claim 10 wherein the second distance is in the range from 0.5 to 10 mm.

13. An arrangement comprising a first structure A as recited in claim 1, and a further structure B wherein
a. the first structure A comprises
i. a first plurality of receptacles A, wherein the receptacles A of the first plurality of receptacles
A. have first ends A and further ends A,
B. comprise sidewalls A at least partially enclosing interiors A of the receptacles A,
C. comprise protrusions A that extend into the interiors A of the receptacles A;
b. the further structure B comprises
i. a further plurality of receptacles B, wherein the receptacles B of the further plurality of receptacles
A. have first ends B and further ends B,
B. comprise sidewalls B at least partially enclosing interiors B of the receptacles B,
C. comprise protrusions B that extend into the interiors B of the receptacles B;
wherein
the structure B is arranged in contact with the structure A such that at least one or all of the following applies:
I. 30% or less of the receptacles A are in contact with the protrusions B, and/or
II. 30% or less of the receptacles B are in contact with the protrusions A.

14. A method for processing at least two structures, comprising the steps of
a. providing a first structure A as recited in claim 1, and a further structure B, wherein
i. the first structure A comprises a first plurality of receptacles A, wherein the receptacles A of the first plurality of receptacles
A. have first ends A and further ends A,
B. comprise sidewalls A at least partially enclosing interiors A of the receptacles A,
C. comprise protrusions A that extend into the interiors A of the receptacles A;
ii. the further structure B comprises a further plurality of receptacles B, wherein the receptacles B of the further plurality of receptacles
A. have first ends B and further ends B,
B. comprise sidewalls B at least partially enclosing interiors B of the receptacles B,
C. comprise protrusions B that extend into the interiors B of the receptacles B;
b. arranging the first structure A to be in contact with the further structure B such that
I. 30% or less of the receptacles A are in contact with the protrusions B, and/or
II. 30% or less of the receptacles B are in contact with the protrusions A.

15. A method of employing the first structure as recited in claim 1, the method comprising for at least one the following:
a. reducing a force necessary for removing the first structure and a further structure from each other when the first structure is in contact with the further structure;
b. reducing contact between the receptacles of the first structure and protrusions of a further structure, with the protrusions extending into the interiors of receptacles of the further structure or reducing contact between the receptacles of the further structure and protrusions of the first structure, with the protrusions extending into the interiors of receptacles of the first structure, when the first structure and the further structure are in contact;
c. reducing a particle formation on the first structure when the first structure is in contact with a further structure;
d. reducing contact of the sidewalls of the first structure with a further structure or to reducing contact of the sidewalls of the further structure with the first structure when the first structure and further structure are in contact;
e. reducing a movement of the first structure with respect to a further structure when the first structure and further structure are in contact.
